(19) United States
(12) Patent Application Publication
(10) Pub. No.: US 2025/0232203 A1
(43) Pub. Date: Jul. 17, 2025

(54) BALANCED TWIRLING FOR QUANTUM CIRCUITS

(71) Applicant: International Business Machines Corporation, Armonk, NY (US)

(72) Inventors: Ewout van den Berg, Bronxville, NY (US); Christopher James WOOD, Long Island City, NY (US); Takashi Ido, Bunkyo-ku (JP)

(21) Appl. No.: 18/410,111

(22) Filed: Jan. 11, 2024

(51) Int. Cl. G06N 10/70; G06N 10/20

(52) U.S. Cl. CPC G06N 10/70; G06N 10/20

(57) ABSTRACT

A system comprises a memory that stores and a processor that executes computer executable components stored in the memory, wherein the computer executable components comprise an identification component that identifies a quantum channel within a quantum circuit that is configured for execution at a quantum processor, an evaluation component that generates a reshaped quantum channel based on application of quantum twirling to the quantum channel, and a distribution component that employs a fixed distribution of a specified set of twirl groups over which the quantum twirling is directed by the system.

### BACKGROUND

The subject disclosure relates to quantum computing systems and more specifically to shaping of noise of a quantum channel of a quantum circuit using a quantum computing system.

### SUMMARY

The following presents a summary to provide a basic understanding of one or more embodiments described herein. This summary is not intended to identify key or critical elements, and/or to delineate scope of particular embodiments or scope of claims. Its sole purpose is to present concepts in a simplified form as a prelude to the more detailed description that is presented later. In one or more embodiments, systems, computer-implemented methods, apparatuses and/or computer program products described herein can provide for shaping of noise of a quantum channel of a quantum circuit.

In accordance with an embodiment, a system can comprise a memory that stores and a processor that executes computer executable components stored in the memory, wherein the computer executable components comprise an identification component that identifies a quantum channel within a quantum circuit that is configured for execution at a quantum processor, an evaluation component that generates a reshaped quantum channel based on application of quantum twirling to the quantum channel, and a distribution component that employs a fixed distribution of a specified set of twirl groups over which the quantum twirling is directed by the system.

In accordance with another embodiment, a computer-implemented method can comprise identifying, by a system operatively coupled to a processor, a quantum channel within a quantum circuit that is configured for execution at a quantum processor, generating, by the system, a reshaped quantum channel based on application of quantum twirling to the quantum channel, and employing, by the system, a fixed distribution of a specified set of twirl groups over which the quantum twirling is directed by the system.

In accordance with still another embodiment, a computer program product, facilitating a process to provide shaping of noise of a quantum channel of a quantum circuit, can comprise a computer readable storage medium having program instructions embodied therewith, the program instructions executable by a processor to cause the processor to identify, by the processor, the quantum channel within the quantum circuit that is configured for execution at a quantum processor, generate, by the processor, a reshaped quantum channel based on application of quantum twirling to the quantum channel, and employ, by the processor, a fixed distribution of a specified set of twirl groups over which the quantum twirling is directed by the system.

A benefit of the system, computer-implemented method and/or computer program product can be an ability to, during quantum experiment setup, shape the noise of a noisy quantum channel in a manner that converges to the expectation value faster, using quantum twirling, than existing frameworks.

Another benefit of the system, computer-implemented method and/or computer program product can be an ability to provide the noise shaping for readout quantum circuits, quantum circuits comprising multiple noisy channels, and/or noisy channels to be executed of a plurality of qubits.

Yet another benefit of the system, computer-implemented method and/or computer program product can be an ability for use thereof with varying variations of modified quantum circuit grouping, including block sampling, batch sampling, batch-balanced sampling, repeated batch-balanced sampling, and/or a further variation of any of these variations, without being limited thereto.

Still another benefit of the system, computer-implemented method and/or computer program product can be an increased efficiency of quantum twirling applied to a quantum channel by providing for more accurate expectation values from execution of a set of modified quantum circuits used for the quantum twirling than from execution of a same number of quantum circuits used for quantum twirling based on an existing framework.

### DESCRIPTION OF THE DRAWINGS

FIG. 1 illustrates a block diagram of an example, non-limiting system that can provide a process to shape noise of a quantum channel, in accordance with one or more embodiments described herein.

FIG. 2A illustrates a block diagram of another example, non-limiting system that can provide a process to shape noise of a quantum channel, in accordance with one or more embodiments described herein.

FIG. 2B illustrates a schematic diagram comprising a set of inputs and outputs of the non-limiting system of FIG. 2A.

FIG. 3 illustrates a block diagram of a quantum system that can be employed in connection with the non-limiting systems of FIGS. 1 and 2A, in accordance with one or more embodiments described herein.

FIG. 4 provides a set of schematic illustrations of results of processes that can be performed by the non-limiting system of FIG. 2A, in accordance with one or more embodiments described herein.

FIG. 5 provides another set of schematic illustrations of results of processes that can be performed by the non-limiting system of FIG. 2A, in accordance with one or more embodiments described herein.

FIG. 6A illustrates a set of graphs demonstrating one or more processes that can be performed by the non-limiting system of FIG. 2A, in accordance with one or more embodiments described herein.

FIG. 6B illustrates another graph demonstrating one or more processes that can be performed by the non-limiting system of FIG. 2A, in accordance with one or more embodiments described herein.

FIG. 7A illustrates a set of graphs demonstrating one or more processes that can be performed by the non-limiting system of FIG. 2A, in accordance with one or more embodiments described herein.

FIG. 7B illustrates another graph demonstrating one or more processes that can be performed by the non-limiting system of FIG. 2A, in accordance with one or more embodiments described herein.

FIG. 8 illustrates a set of graphs demonstrating one or more processes that can be performed by the non-limiting system of FIG. 2A, in accordance with one or more embodiments described herein.

FIG. 9A illustrates a set of graphs demonstrating one or more processes that can be performed by the non-limiting system of FIG. 2A, in accordance with one or more embodiments described herein.

FIG. 9B illustrates another graph demonstrating one or more processes that can be performed by the non-limiting system of FIG. 2A, in accordance with one or more embodiments described herein.

FIG. 10A illustrates a set of graphs demonstrating one or more processes that can be performed by the non-limiting system of FIG. 2A, in accordance with one or more embodiments described herein.

FIG. 10B illustrates another set of graphs demonstrating one or more processes that can be performed by the non-limiting system of FIG. 2A, in accordance with one or more embodiments described herein.

FIG. 11 illustrates a flow diagram of one or more processes that can be performed by the non-limiting system of FIG. 2A, to shape noise of a quantum channel, in accordance with one or more embodiments described herein.

FIG. 12 illustrates a continuation of the flow diagram of FIG. 11 of one or more processes that can be performed by the non-limiting system of FIG. 2A, in accordance with one or more embodiments described herein.

FIG. 13 illustrates a block diagram of an example, non-limiting, computer environment in accordance with one or more embodiments described herein.

### DETAILED DESCRIPTION

The following detailed description is merely illustrative and is not intended to limit embodiments and/or application or utilization of embodiments. Furthermore, there is no intention to be bound by any expressed or implied information presented in the preceding Summary section, or in the Detailed Description section. One or more embodiments are now described with reference to the drawings, wherein like reference numerals are utilized to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

In practice, operations on qubits generally can introduce some error, such as some level of decoherence and/or some level of quantum noise, further affecting qubit availability. Quantum noise can refer to noise attributable to the discrete and/or probabilistic natures of quantum interactions. In one or more embodiments, the noise can be attributable to the hardware employed. In one or more embodiments, the noise can be attributable to the software and/or quantum gates being executed.

Noise attributable to quantum gates being executed can be shaped. This shaping of the noise can include, but not necessarily, a reduction of the noise, but is not necessarily noise mitigation. Rather, noise shaping can be employed to change one or more characteristics of the noise, such that the noise can be more efficiently mitigated and/or analyzed.

For example, consider a 10×10 Pauli transfer matrix having noise attributable to each of the 10×10 elements of the matrix. Application of noise shaping can, for instance, reshape the noise to be directed more generally along a diagonal of the Pauli transfer matrix, by reducing and/or eliminating noise corresponding to matrix elements adjacent to and/or spaced from the diagonal.

One noise shaping process is that of quantum twirling, which is a technique that functions by conjugating a noise channel (e.g., a quantum channel having undesirable noise attributable thereto) using quantum gates from a predefined twirl group [symbol] ={G₁, . . . Gₖ}.

Quantum twirls are generally implemented by generating a set of quantum circuits in which each twirl is replaced by a single element of a set of corresponding twirl groups, which twirl groups are sampled independently and identically distributed (IID) at random. As the number of sampled quantum circuits grows, the average expectation value of the expectation values of the quantum circuits increasingly behaves as the desired (mathematical) twirl.

As a result, an expectation value over the twirl group gives a map that has certain beneficial properties. For instance, by choosing the twirl group to coincide with a corresponding Pauli group the noise channel can be shaped into a Pauli noise channel. Other twirl groups may, for instance, average certain channel fidelities, manage bitflips of a readout circuit, etc.

Mathematically, given a noise channel Λ(ρ), and a specified set [symbol] ={G₁, . . . Gₖ}, of twirl groups G, a quantum twirl can be defined as:

$$\frac{1}{\vert \vert} {\sum }_{G ∈} {G}^{†} Λ ( G ρ {G}^{†} ) G . \qquad Equation 1$$

At Equation 1, G^{†} denotes an adjoint of the operator G. As used herein, an adjoint operator mimics behavior of a transpose matrix on real Euclidian space. Also at Equation 1,

$$\frac{1}{\vert \vert}$$

is 1 over the quantity of elements in the set (e.g., such as k elements).

A twirl group G can be defined as one or more quantum gates of a total twirl group set {G₁, . . . Gₖ}. For example, a twirl group set can comprise {I, X, Y and Z}. Another twirl group set can comprise {I, Rz(pi/2)}.

Quantum measurement results 320, resulting from execution of a set of quantum circuits defined by the quantum twirling, e.g., employing Equation 1, can result in a set of expectation values. An average of these expectation values can be employed to define a reshaped quantum channel Λ_{R}(ρ) having reduced and/or otherwise shaped noise, as compared to the initial quantum channel Λ(ρ).

However, when defining a reshaped quantum channel Λ_{R}(ρ), existing frameworks employ random sampling, such as independent and identically distributed (IID) sampling, when permuting G. This causes inefficiency of convergence to an average expectation value. For example, the number of samples executed, e.g., number of shots/quantum circuits executed, such as employing Equation 1, can be unnecessarily large or inefficient. Further, convergence often can be overshot or simply unattainable.

That is, sampling twirl elements G independently will generally yield an undesirably skewed distribution of samples where some twirl elements occur more often than others. This can particularly be the case when a total number of samples is relatively small. When a total number of samples is relatively large, convergence overshooting can result. One or more of these imbalances can reduce the efficiency of the quantum twirling, resulting in reduced accuracy of correspondingly determined expectation values.

As an example, consider a Pauli twirl on a single qubit. As used herein, Pauli twirling is a special instance of quantum twirling where the set of twirl group consists of all n-qubit Pauli operators. More specifically, a Pauli rotation twirl comprises choosing a set of twirl groups, depending on the operator, to consist of all Pauli rotations. By choosing certain rotation angles, averaging of certain Pauli fidelities can be made more efficient.

If sampling twirl gates independently, quantum circuit execution generally results in poor averaging over 4 circuits and requires substantially larger number of circuit instances before each Pauli occurs close to 25% of the time.

Differently, using the one or more embodiments described herein, relative to a noise channel, a system described herein can average X and Y fidelities by using a rotational twirl with gates {I, Rz(pi/2)}, each chosen with probability ½. That is, the one or more systems described herein can employ a balanced and fixed distribution. For example, relative to the instant example, 2 circuit instances can be employed (or multiples of 2 circuit instances, where each of the twirl gates is used in 50% of the circuits, or close to 50%) to implement the twirl.

Alternatively, sampling the terms independently and identically distributed (IID) at random, as in existing frameworks, generally gives large deviations between sums of individual twirl groups of a set of twirl groups.

That is, to account for one or more of the aforementioned deficiencies of existing quantum channel noise shaping frameworks for quantum systems, one or more embodiments described herein can provide a framework having a more balanced approach to sampling of twirl groups G.

As used herein, the term “balanced” can be used to describe a desirable permutated distribution of twirl groups, to each be used for generating a respective quantum circuit to be executed at a quantum system, resulting in a set of expectation values, which expectation values can be averaged to determine an averaged expectation value, and subsequently a reshaped quantum channel Λ_{R}(ρ) having reduced and/or otherwise shaped noise, as compared to the initial quantum channel Λ(ρ).

The term “balanced distribution” can refer to a distribution of the twirl groups that is close to equal. For example, for a three-type (A, B and C) set of twirl groups, there may be 2As, 2Bs and 2Cs, providing purely equal distribution among A, B and C. In another example, there may be 2As, 2Bs and 1C, which while not a purely equal distribution, is still a balanced distribution with an individual deviation of 50%. As used herein, an “individual deviation” can refer to the deviation between the sum of any one twirl group of a set as compared to the sum of any one other twirl group of the same set. As another example, a larger set might comprise 12As, 10Bs and 9Cs. This distribution can still be considered a balanced distribution with an individual deviation for C of 25%, as compared to A.

One or more frameworks, according to the one or more embodiment described herein, can employ permutation of the twirl groups G based on a fixed distribution of the twirl groups, regardless of whether the twirl groups are employed one or more times per twirl group, and regardless of how many samples are specified. Indeed, providing for a fixed distribution, with a known (rather than random) distribution, whether of a purely equal distribution or an otherwise balanced distribution as described herein, can allow for a more predictable and efficient convergence to the average expectation value as compared to existing frameworks.

It is noted that within the fixed distribution, an order (e.g., an order in which modified quantum circuits employing the twirl groups can be performed) of the different twirl groups of a batch, block or other grouping can be internally randomly permutated (e.g., AABCCB) or otherwise specified (e.g., AABBCC or ABCABC).

In view of at least the foregoing, the one or more frameworks discovered by the inventors and described herein can be employed for noise shaping for quantum channels of readout quantum circuits, quantum circuits comprising multiple noisy channels, quantum channels that can be expressed or closely approximated by a tensor product of smaller noise channels, and/or noisy channels to be executed of a plurality of qubits. Further, the one or more frameworks discovered by the inventors and described herein can be employed with varying variations of modified quantum circuit grouping, including block sampling, batch sampling, batch-balanced sampling, repeated batch-balanced sampling, and/or a further variation of any of these variations, without being limited thereto.

As a result, shaping of one or more noisy quantum channels can be provided in a manner that converges to the expectation value faster, using quantum twirling, than existing frameworks. Put another way, the one or more frameworks discovered by the inventors and described herein can provide an increased efficiency of quantum twirling applied to a quantum channel by providing for more accurate expectation values from execution of a set of modified quantum circuits used for the quantum twirling than from execution of a same number of quantum circuits used for quantum twirling based on an existing framework.

As such, the one or more embodiments herein can provide for automatic or at least partially automatic generation of, and direction of execution of, a set of quantum circuits for determining a modified, or noise-shaped, quantum channel from an initial quantum channel. The one or more embodiments described herein can employ a combination of classical and quantum processes performed on physical qubits of a quantum processor to provide one or more quantum measurement readouts that can be employed, by the one or more embodiments, to determine one or more expectation values, which in turn can be employed, by the one or more embodiments, to determine the reshaped quantum channel (also herein referred to as a reshaped noise channel and/or reshaped quantum noise channel).

As used herein, the term “data” can comprise metadata.

As used herein, the terms “entity,” “requesting entity,” and “user entity” can refer to a machine, device, component, hardware, software, smart device, party, organization, individual and/or human.

One or more embodiments are now described with reference to the drawings, where like referenced numerals are used to refer to like elements throughout. In the following description, for purposes of explanation, numerous specific details are set forth to provide a more thorough understanding of the one or more embodiments. It is evident in various cases, however, that the one or more embodiments can be practiced without these specific details.

Further, it should be appreciated that the embodiments depicted in one or more figures described herein are for illustration only, and as such, the architecture of embodiments is not limited to the systems, devices and/or components depicted therein, nor to any particular order, connection and/or coupling of systems, devices and/or components depicted therein.

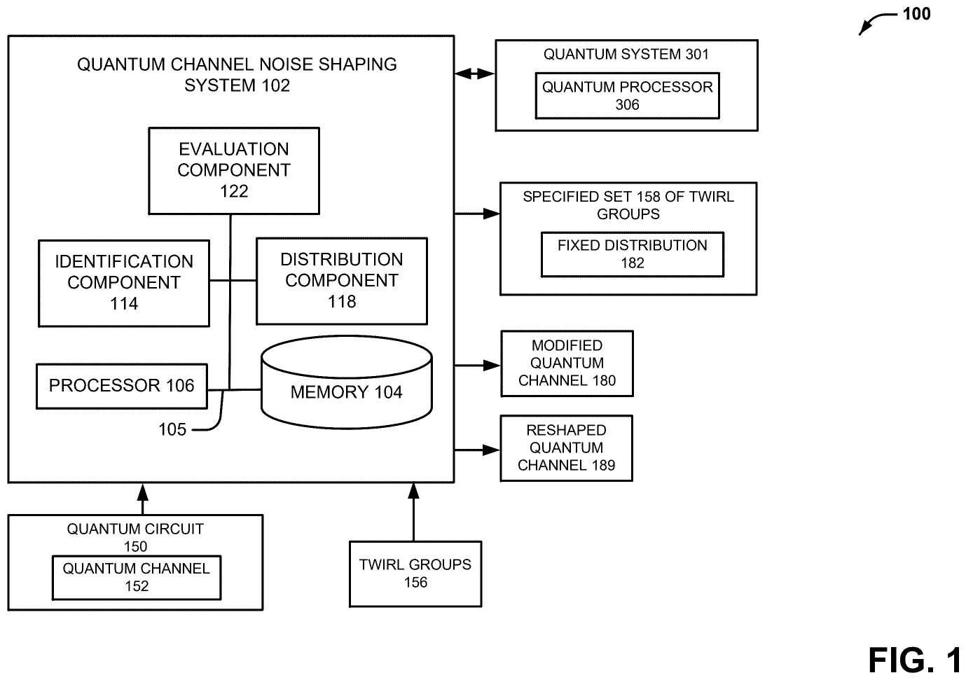

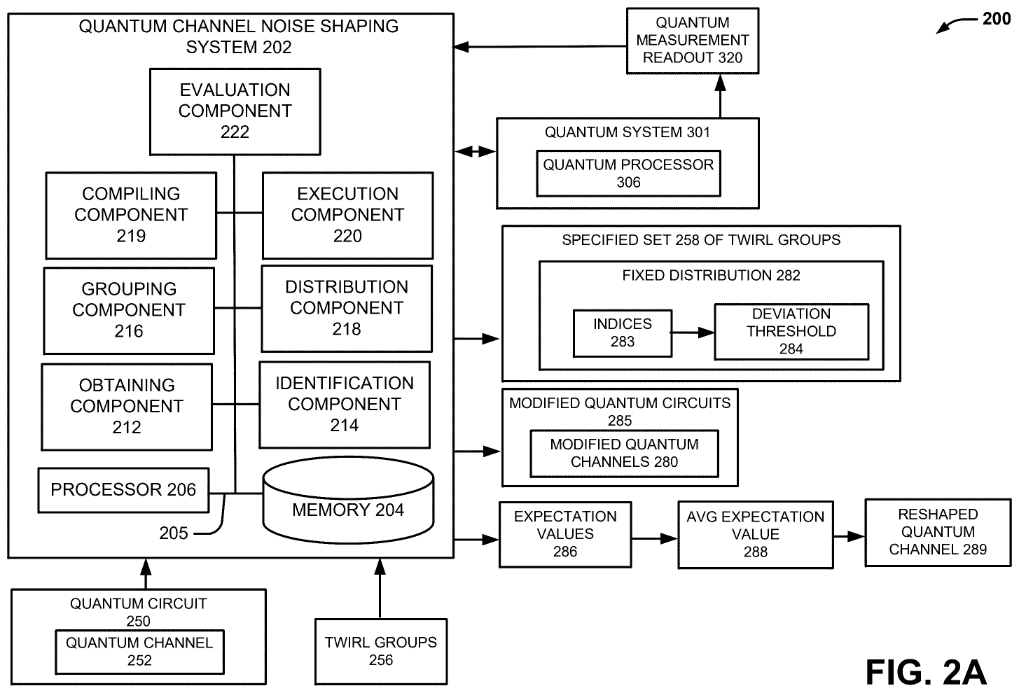

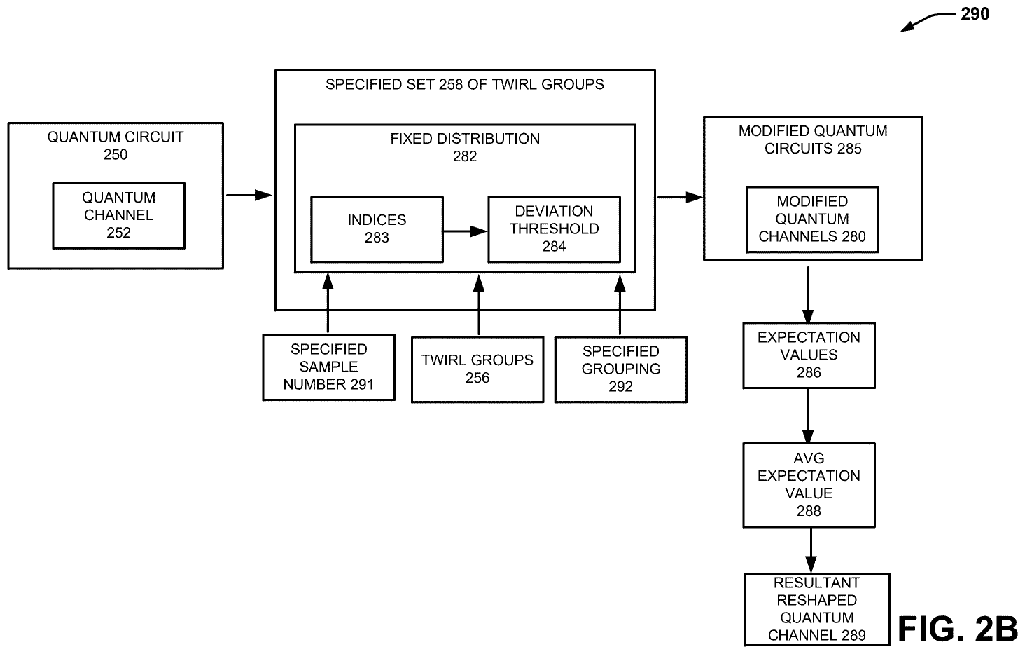

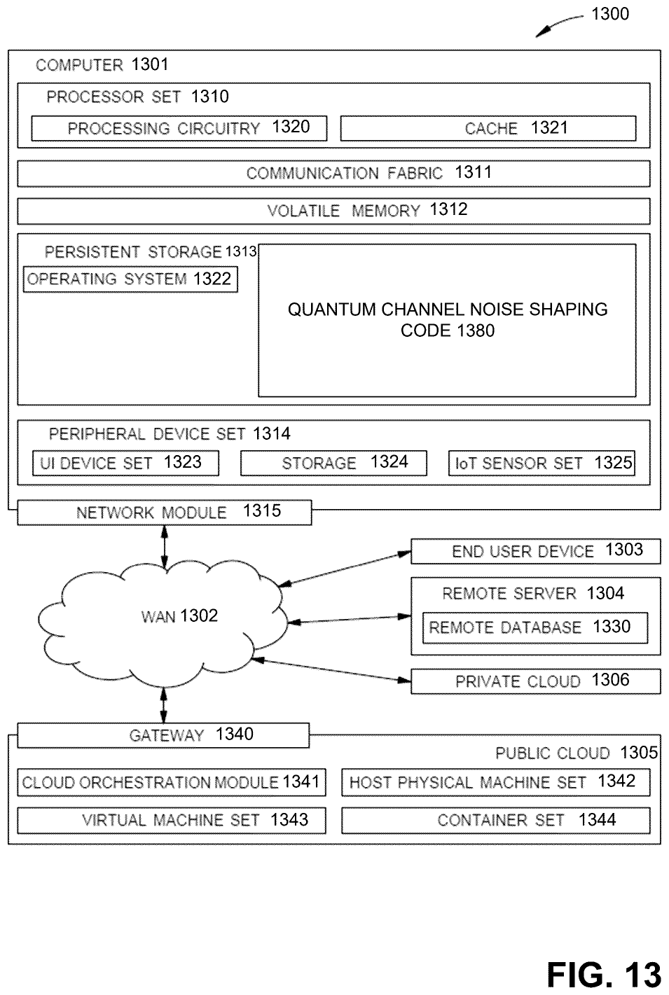

For example, in one or more embodiments, the non-limiting systems 100 and/or 200 illustrated at FIGS. 1 and 2A, and/or systems thereof, can further comprise one or more computer and/or computing-based elements described herein with reference to a computing environment, such as the computing environment 1300 illustrated at FIG. 13. In one or more described embodiments, computer and/or computing-based elements can be used in connection with implementing one or more of the systems, devices, components and/or computer-implemented operations shown and/or described in connection with FIGS. 1 and/or 2A and/or with one or more other figures described herein.

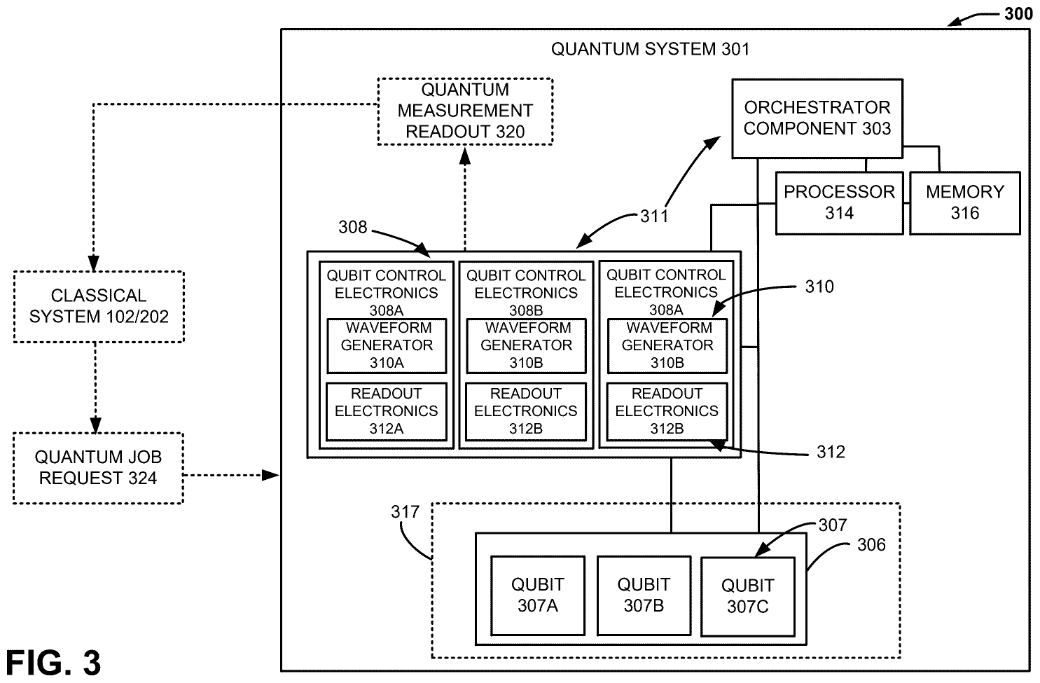

Turning now in particular to one or more figures, and first to FIG. 1, the figure illustrates a block diagram of an example, non-limiting system 100 that can facilitate shaping of noise of a quantum channel 152 of a quantum circuit 150 to be executed at a quantum system 301 (FIG. 3).

The non-limiting system 100 can comprise a quantum channel noise shaping system 102 and a quantum system 301, to be described in detail below. It is noted that the quantum channel noise shaping system 102 is only briefly described relative to FIG. 1 to provide but a lead-in to description of a more complex and/or more expansive quantum channel noise shaping system 202 as illustrated at FIG. 2A. That is, further detail regarding processes that can be performed by one or more embodiments described herein will be provided below relative to the non-limiting system 200 of FIG. 2A.

Still referring to FIG. 1, the quantum channel noise shaping system 102 can comprise at least a memory 104, bus 105, processor 106, identification component 114, distribution component 118 and/or evaluation component 122. Using these components and the quantum system 301, the quantum channel noise shaping system 102 can provide for generation of a noise-reshaped quantum channel 189, having shaped noise as compared to the quantum channel 152.

Generally, the identification component 114 can identify a quantum channel 152 within a quantum circuit 150 that is configured for execution at a quantum processor 306 having one or more physical qubits.

A distribution component 118 generally can employ a fixed distribution 182 of a specified set 158 of twirl groups 156 over which quantum twirling is directed by the system 102.

The evaluation component 122 generally can generate a reshaped quantum channel 189 based on application of the quantum twirling, using the fixed distribution 182, where the quantum twirling can be directed by the system 102. The resulting reshaped quantum channel 189 can be analyzed, noise mitigated, and/or employed for use in a quantum circuit executed at the quantum system 301, without being limited thereto.

It is noted that the identification component 114, the distribution component 118 and/or the evaluation component 122 can operate at a classical system of and/or comprising the quantum channel noise shaping system 102.

In general, the non-limiting system 100 can employ any suitable method of communication (e.g., electronic, communicative, internet, infrared, fiber, etc.) to provide communication between the classical system 102 and the quantum system 301.

Turning next to FIG. 2A, a non-limiting system 200 is illustrated that can comprise a quantum channel noise shaping system 202. Repetitive description of like elements and/or processes employed in respective embodiments is omitted for sake of brevity. Description relative to an embodiment of FIG. 1 can be applicable to an embodiment of FIG. 2A. Likewise, description relative to an embodiment of FIG. 2A can be applicable to an embodiment of FIG. 1.

Generally, the non-limiting system 200 that can facilitate shaping of noise of a quantum channel 252 of a quantum circuit 250 to be executed at a quantum system 301 (FIG. 3).

Turning first to the quantum channel noise shaping system 202, one or more communications between one or more components of the non-limiting system 200 can be provided by wired and/or wireless means including, but not limited to, employing a cellular network, a wide area network (WAN) (e.g., the Internet), and/or a local area network (LAN). Suitable wired or wireless technologies for supporting the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Area Networks), Z-Wave, an advanced and/or adaptive network technology (ANT), an ultra-wideband (UWB) standard protocol and/or other proprietary and/or non-proprietary communication protocols.

The quantum channel noise shaping system 202 can be associated with, such as accessible via, a cloud computing environment.

The quantum channel noise shaping system 202 can comprise a plurality of components. The components can comprise a memory 204, processor 206, bus 205, obtaining component 212, identification component 214, grouping component 216, distribution component 218, compiling component 219, execution component 220 and/or evaluation component 222. Using these components, and using operation of the quantum system 301, the non-limiting system 200 generally can provide one or more quantum measurement readouts 320 that can be employed, by the one or more embodiments, to determine one or more expectation values 286, which in turn can be employed, by the one or more embodiments, to determine the reshaped quantum channel 289.

That is, the obtaining component 212, identification component 214, grouping component 216, distribution component 218, compiling component 219, execution component 220 and/or evaluation component 222 can operate at the classical system 202 of the non-limiting system 200. Differently, one or more quantum circuits (e.g., modified quantum circuits 285) can be executed by the quantum system 301. In one or more other embodiments, one or more processes performed by any one or more of the obtaining component 212, identification component 214, grouping component 216, distribution component 218, compiling component 219, execution component 220 and/or evaluation component 222 can be performed at the quantum system 301.

Discussion first turns briefly to the processor 206, memory 204 and bus 205 of the quantum channel noise shaping system 202. For example, in one or more embodiments, the quantum channel noise shaping system 202 can comprise the processor 206 (e.g., computer processing unit, microprocessor, classical processor, quantum processor and/or like processor). In one or more embodiments, a component associated with quantum channel noise shaping system 202, as described herein with or without reference to the one or more figures of the one or more embodiments, can comprise one or more computer and/or machine readable, writable and/or executable components and/or instructions that can be executed by processor 206 to provide performance of one or more processes defined by such component and/or instruction. In one or more embodiments, the processor 206 can comprise the obtaining component 212, identification component 214, grouping component 216, distribution component 218, compiling component 219, execution component 220 and/or evaluation component 222.

In one or more embodiments, the quantum channel noise shaping system 202 can comprise the computer-readable memory 204 that can be operably connected to the processor 206. The memory 204 can store computer-executable instructions that, upon execution by the processor 206, can cause the processor 206 and/or one or more other components of the quantum channel noise shaping system 202 (e.g., obtaining component 212, identification component 214, grouping component 216, distribution component 218, compiling component 219, execution component 220 and/or evaluation component 222) to perform one or more actions. In one or more embodiments, the memory 204 can store computer-executable components (e.g., obtaining component 212, identification component 214, grouping component 216, distribution component 218, compiling component 219, execution component 220 and/or evaluation component 222).

The quantum channel noise shaping system 202 and/or a component thereof as described herein, can be communicatively, electrically, operatively, optically and/or otherwise coupled to one another via a bus 205. Bus 205 can comprise one or more of a memory bus, memory controller, peripheral bus, external bus, local bus, quantum bus and/or another type of bus that can employ one or more bus architectures. One or more of these examples of bus 205 can be employed.

In one or more embodiments, the quantum channel noise shaping system 202 can be coupled (e.g., communicatively, electrically, operatively, optically and/or like function) to one or more external systems (e.g., a non-illustrated electrical output production system, one or more output targets and/or an output target controller), sources and/or devices (e.g., classical and/or quantum computing devices, communication devices and/or like devices), such as via a network. In one or more embodiments, one or more of the components of the quantum channel noise shaping system 202 and/or of the non-limiting system 200 can reside in the cloud, and/or can reside locally in a local computing environment (e.g., at a specified location).

In general, the non-limiting system 200 can employ any suitable method of communication (e.g., electronic, communicative, internet, infrared, fiber, etc.) to provide communication between the quantum channel noise shaping system 202 and the quantum system 301.

In addition to the processor 206 and/or memory 204 described above, the quantum channel noise shaping system 202 can comprise one or more computer and/or machine readable, writable and/or executable components and/or instructions that, when executed by processor 206, can provide performance of one or more operations defined by such component and/or instruction.

Discussion next turns to the additional components of the quantum channel noise shaping system 202 (e.g., obtaining component 212, identification component 214, grouping component 216, distribution component 218, compiling component 219, execution component 220 and/or evaluation component 222).

Turning first to the obtaining component 212, the obtaining component 212 generally can find, locate, determine, request, download, read and/or otherwise obtain a quantum circuit 250 and/or a quantum job request 324 comprising a quantum circuit 250.

Based on the one or more processes of the obtaining component 212, the identification component 214 generally can identify a quantum channel 252 within the quantum circuit 250 that is configured for execution at a quantum processor 306 having one or more physical qubits 307 (FIG. 3). The quantum channel 252 can comprise one or more quantum gates to be executed at the quantum system 301, and particularly at the quantum processor 306 thereof.

Next, prior to discussion of shaping of noise of the obtained quantum channel 252, discussion first turns to a general description of an exemplary quantum system 301 that can be employed to provide the noise shaping, in connection with the classical system 202.

Turning to FIG. 3, one or more embodiments described herein can include one or more devices, systems and/or apparatuses that can provide a process to generate one or more waveforms or pulses for a quantum-based operation (e.g., using a quantum device), such as for operating one or more qubits of a quantum device. Accordingly, at FIG. 3, illustrated is a block diagram of an example, non-limiting system 300 that can at least partially facilitate such a process. While referring here to one or more processes, facilitations and/or uses of the non-limiting system 300, description provided herein, both above and below, also can be relevant to one or more other non-limiting systems described herein, such as the non-limiting systems 100 and/or 200.

As illustrated at FIG. 3, the non-limiting system 300 can comprise a quantum system 301 that can be employed with or separate from the classical systems 102/202.

Generally, the quantum system 301 (e.g., quantum computer system, superconducting quantum computer system and/or the like) can employ quantum algorithms and/or quantum circuitry, including computing components and/or devices, to perform quantum operations and/or functions on input data to produce results that can be output to an entity. The quantum circuitry can comprise quantum bits (qubits), such as multi-bit qubits, physical circuit level components, high level components and/or functions. The quantum circuitry can comprise physical pulses that can be structured (e.g., arranged and/or designed) to perform desired quantum functions and/or computations on data (e.g., input data and/or intermediate data derived from input data) to produce one or more quantum results as an output. The quantum results, e.g., quantum measurement readout 320, can be responsive to the quantum job request 324 and associated input data and can be based at least in part on the input data, quantum functions and/or quantum computations.

In one or more embodiments, the quantum system 301 can comprise components, such as an orchestrator component 303, a quantum processor 306, pulse component (e.g., a waveform generator 310) and/or a readout electronics 312 (e.g., readout component).

The quantum processor 306 can comprise one or more, such as plural, qubits 307. Individual qubits 307A, 307B and 307C, for example, can be fixed frequency and/or single junction qubits, such as transmon qubits.

In one or more embodiments, a readout resonator can be associated with, such as located with physical hardware defining a qubit 307.

In one or more embodiments, a memory 316 and/or processor 314 can be associated with the orchestrator component 303, where suitable. The processor 314 can be any suitable processor. The processor 314 can generate one or more instructions for controlling the one or more processes of the orchestrator component 303, such as for controlling one or more subordinate controllers (e.g., qubit control electronics 308).

The orchestrator component 303 can obtain (e.g., download, receive, search for and/or the like) a quantum job request 324 requesting execution of one or more quantum programs and/or a physical qubit layout. The quantum job request 324 can be provided in any suitable format, such as a text format, binary format and/or another suitable format. In one or more embodiments, the quantum job request 324 can be obtained by a component other than of the quantum system 301, such as a by a component of the classical systems 102/202.

The orchestrator component 303 can determine mapping of one or more quantum logic circuits for executing a quantum program. In one or more embodiments, the orchestrator component 303 and/or quantum processor 306 can direct the waveform generator 310 to generate one or more pulses, tones, waveforms and/or the like to affect one or more qubits 307, such as in response to a quantum job request 324.

In one or more embodiments, more than one orchestrator component 303 can be comprised by the quantum system 301. The one or more orchestrator components 303 can be employed to control one or more qubit control electronics 308. Thus, the one or more qubit control electronics 308A, 308B and/or 308C can be communicatively coupled to the one or more orchestrator components 303.

Qubit control electronics 308 can be employed by the quantum processor 306 and disposed within a room temperature environment external to the cryogenic environment 317, as illustrated. In one or more embodiments, one or more aspects of one or more qubit control electronics can be disposed within a cryogenic environment 317.

In one or more embodiments a qubit control electronics 308 can be provided per qubit 307. In one or more embodiments, a qubit control electronics 308 can be provided to communicate with more than one qubit 307 per that qubit control electronics 308.

In one or more embodiments, a qubit control electronics 308 can be and/or can comprise a qubit drive card (e.g., a waveform generator 310) and/or a qubit acquire card (e.g., readout electronics 312). In one or more embodiments, a qubit control electronics 308 can be and/or can comprise only one of a qubit drive card or a qubit acquire card. In one or more embodiments, a qubit control electronics 308 can comprise more than one qubit drive card and/or more than one qubit acquire card.

A waveform generator 310 generally can cause at least one qubit 307 of the quantum processor 306 to perform one or more quantum processes, calculations and/or measurements by creating a suitable electro-magnetic signal. For example, the waveform generator 310 can operate one or more qubit effectors, such as qubit oscillators, harmonic oscillators, pulse generators and/or the like to cause one or more pulses to stimulate and/or manipulate the state(s) of the one or more qubits 307 comprised by the quantum system 301. Indeed, a signal can be generated by the waveform generator 310 to affect one or more of the plurality of qubits 307.

In one or more embodiments, the waveform generator 310 can direct application of such electro-magnetic signal by use of the various qubit control electronics 308.

The quantum processor 306 can be contained in a cryogenic environment, such as generated by a cryogenic environment 317, such as effected by a dilution refrigerator. Where the plurality of qubits 307 are superconducting qubits, cryogenic temperatures, such as about 4K or lower, can be employed for function of these physical qubits.

The readout electronics 312 can comprise and/or be comprised by the acquire card. The readout electronics 312 and/or the acquire card can comprise an analog to digital converter (ADC) 315 that can be employed for the readout path of one or more qubits 307. The readout electronics 312, or at least a portion thereof, can be contained in a room temperature environment or the cryogenic environment 317, such as for reading a state, frequency and/or other characteristic of qubit, excited, decaying or otherwise. Accordingly, one or more elements of the readout electronics 312 also can be constructed to perform at such cryogenic temperatures.

In one or more embodiments, more than one cryogenic environment, such as more than one dilution refrigerator, can be comprised by the quantum system 301.

It is noted that one or more aspects of the aforementioned description can refer to operation of a single set of instructions run on a single qubit controller or set of qubit control electronics. However, scaling can be achieved. For example, instructions can be calculated, transmitted, employed and/or otherwise used relative to one or more qubits (e.g., non-neighbor qubits) in parallel with one another, one or more quantum circuits in parallel with one another, and/or one or more qubit mappings in parallel with one another.

Turning now back to FIG. 2A in addition to still referring to FIG. 3, and also how referring to FIG. 2B, discussion turns to one or more processes performed by one or more additional components of the quantum channel noise shaping system 202.

Generally, as illustrated at schematic 290 of FIG. 2B, the grouping component 216, the distribution component 218 and the compiling component 219 can function in concert with one another, in one or more embodiments, for identifying a balanced distribution of twirl groups 256 (e.g., by the distribution component 218), determining how modified quantum circuits 285 are to be grouped (e.g., by the grouping component), and generating a set of the modified quantum circuits 285 (e.g., by the compiling component 219) using the fixed distribution 282, a specified sample number 291, and a specified grouping 292. As such, these components can function in concert with one another for defining a set of shots to be executed at a quantum system 301 for ultimately obtaining data/metadata for generating the resultant reshaped quantum channel 289.

More particularly, the grouping component 216 and/or the distribution component 218 generally can, determine and/or identify a specified sample number 291, of quantum circuit samples, to execute for generating the reshaped noise channel 289. The specified sample number 291 represents the number of quantum circuits to run (different shots to run) to execute a twirling operation, where expectation values 286 resulting from execution of the quantum circuits are employed to generate the reshaped noise channel 289. Accordingly, the specified sample number 291 also represents the quantity of twirl groups 256 to be employed in a specified set 258 of twirl groups by the distribution component 218.

As discussed herein, in one or more embodiments, the specified sample number of quantum circuits and the specified sample number of twirl groups can be reduced due to balanced twirling (e.g., use of a balanced distribution of twirl groups) by the distribution component 218. In one or more other embodiments, the specified sample number of quantum circuits and the specified sample number of twirl groups can be the same and/or similar to that employed for existing methods, but with the specified sample number 291 being employed relative to a balanced distribution of twirl groups 256.

The specified sample number 291 can be specified by a user entity of the non-limiting system, by the grouping component 216 and/or by the distribution component 218.

Accordingly, looking to schematic 290 of FIG. 2B, based on the specified sample number and on an identified set of twirl groups 256 (such as identified by the obtaining component 212), the distribution component 218 generally can generate a balanced distribution of twirl groups 256 over which quantum twirling is to be directed by the system 202.

For example, twirl groups can comprise I, X, Y and Z (or a different combination thereof), I and Rz(pi/2), use and non-use of a bitflip (for a readout quantum circuit, where the quantum channel is the bitflip or no bitflip), or any other suitable set of operators (e.g., quantum gates, Pauli gates, etc.).

In one or more embodiments the distribution component 218 can assign indices 283 to the twirl groups 256. For example, A to I, B to X, C to Y, and D to Z. That is, the indices 283 can merely represent the operators of the twirl groups 256 (e.g., represent the twirl groups).

With or without the indices 283, the distribution component 218 can define a fixed distribution 282 of a specified set 258 of the twirl groups 256. For example, using the indices and a specified sample number of 8 instances, the distribution component 218 can define a fixed distribution 282, such as AABBCCDD, ABDCABDC, ABCCDBAD and/or any other order. That is, the order of the instances within the fixed distribution 282 can be random, with the particular indices/twirl groups used being specified, and with the number of each particular index/twirl group being specified. This is in contrast to pure random assignment of a distribution by existing frameworks, which may, for example, result in any other distribution being non-balanced (e.g., AAABCDAD, BCABBCAC, etc.).

As discussed above, the one or more systems described herein can employ a balanced and fixed distribution, with the number of each twirl group being used being fixed. For example, of a set of twirl groups having four twirl group types (e.g., I, X, Y, Z), or indices 283, can be employed a number of times that is close to equal to, or equal to, the others.

In one or more embodiments, a deviation of a sum of any one index relative to a sum of any other index is less than a specified deviation threshold 284. As used herein, the term “deviation” refers to difference. Thus, for a set of twirl groups having 8 of X, 7 of Y, 8 of Z and 6 of I, 2 is one deviation of any one instance relative to any other instance (8−6=2).

A specified deviation threshold 284 can provide a range, a quantity of instances, a percentage of instances, a standard deviation, exactly equal, and/or any other suitable numerical aspect. In one or more embodiments, a specified deviation threshold can define such deviation as being less than statistically significant, or less than or equal to statistically significant, (e.g., relative to a quantity of one or more other instances) as satisfying a deviation threshold 284.

A specified deviation threshold 284 can be specified by the distribution component 218 and/or by a user entity of the non-limiting system 200.

In concert therewith, using the same specified sample number 291, the grouping component 216 can determine a specified grouping 292. The specified grouping 292 can define to use, and/or how to use, one or more groups of modified quantum circuits 285, where each modified quantum circuit 285 would comprise a modified quantum channel 280, where each modified quantum channel 280 would be based on one instance of the fixed distribution 282.

For example, using a specified grouping 292 of 1 group, and maintaining the previous example, of a specified sample number of 8, and a fixed distribution of ABDCABDC, a set of modified quantum circuits 285 would include 8 modified quantum circuits (MQCs) 285. One MQC would employ A, a second MQC would employ B, a third MQC would employ D, a fourth MQC would employ C, and so on until an eighth MQC that would employ C in its respective modified quantum channel 280. (It is noted that generation of the modified quantum channels 280, and of the modified quantum circuits 285, will be discussed below relative to one or more processes that can be performed by the compiling component 219.)

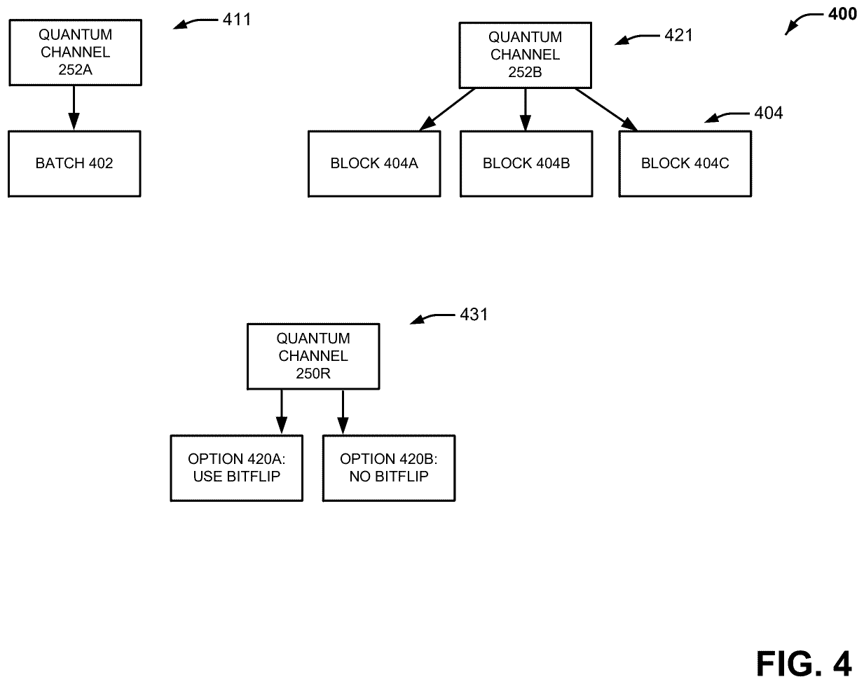

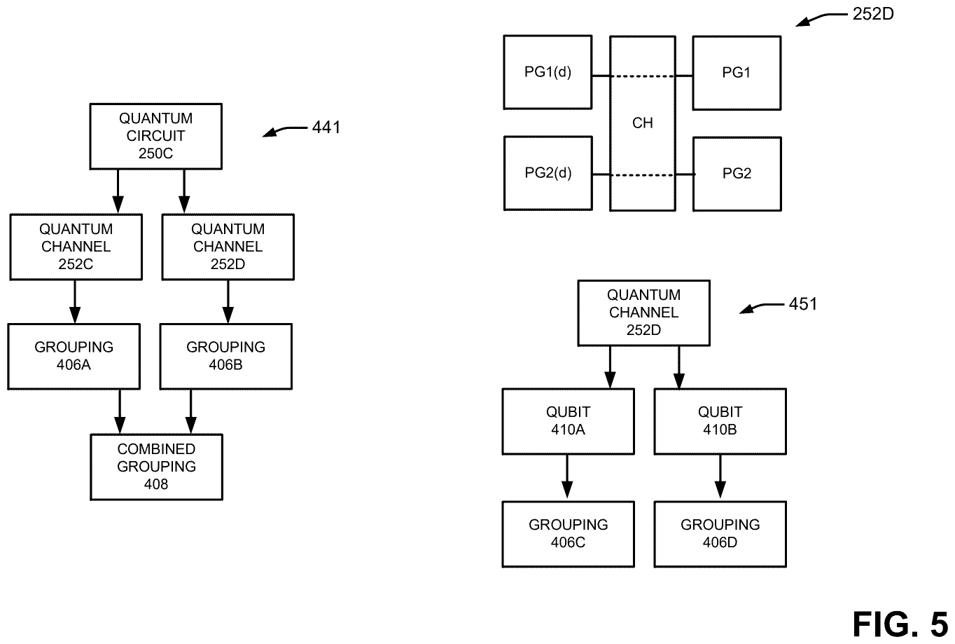

In one or more embodiments, the grouping component 216 can split the sample number into a specified number of groups (e.g., defining a specified grouping 292), such as a number of batches or blocks. As used herein, the term “batch” refers to batch sampling, as described below relative to FIGS. 4 and 5. As used herein, the term “block” refers to block sampling, as described below relative to FIGS. 4 and 5.

In one or more embodiments, the grouping component 216 can group fixed distributions 282 for plural qubits of different or same quantum channels of a same original quantum circuit 250 into a same group (e.g., a batch or block, without being limited thereto). In one or more embodiments, the grouping component 216 can group fixed distributions 282 for plural quantum channels of a same original quantum circuit 250 into a same group (e.g., a batch or block, without being limited thereto).

In one or more embodiments, the grouping component 216 can split a grouping into multiple groupings corresponding to multiple qubits to be employed for a same original quantum channel 252. This can result in different fixed distributions being used for different qubits.

In one or more embodiments, relative to the specified grouping 292 determined by the grouping component 216, the distribution component 218 can employ different fixed distributions for different groups (e.g., for different batches and/or blocks, without being limited thereto). Relative thereto, the distribution component 218 can employ different deviation thresholds 284 for different fixed distributions 282, where suitable.

Based on the fixed distribution 282 and the specified grouping 292, and thus also based on the specified sample number 291, the compiling component 219 can generate a set of modified quantum channels 280 comprising the twirl groups 256 of the fixed distribution 282. The compiling component 219 further can generate a set of modified quantum circuits 285 comprising the modified quantum channels 280.

For example, in one or more embodiments, the compiling component 219 can generated the modified quantum channels 280 as comprising the quantum channel 252 bookended by an adjoint of a twirl group 256, of the fixed distribution 282, before the quantum channel 252 and by the twirl group 256 itself after the quantum channel 252.

For example, as discussed above, mathematically, given a noise channel Λ(ρ) being the quantum channel 252, and a fixed distribution [symbol] ={G₁, . . . Gₖ}, of twirl groups G, a quantum twirl can be defined as:

$$\frac{1}{\vert \vert} {\sum }_{G ∈} {G}^{†} Λ ( G ρ {G}^{†} ) G . \qquad Equation 1$$

At Equation 1, G^{†} denotes an adjoint of the operator G. As used herein, an adjoint operator mimics behavior of a transpose matrix on real Euclidian space. Also at Equation 1,

$$\frac{1}{\vert \vert}$$

is 1 over the quantity of elements in the set (e.g., such as k elements). Further, G^{†}Λ(GρG^{†})G is the modified quantum channel.

Thus, for each modified quantum circuit 285, a different instance of G of the fixed distribution 282 can be employed by the compiling component 219 to generate the modified quantum circuits 285.

An execution component 220 can direct execution of the set of modified quantum circuits 285 at the quantum processor 306. For example, the execution component 220 can send and/or otherwise make available a quantum job request 324 comprising one or more modified quantum circuits 285. In one or more embodiments, the execution component 220 can communicate with an orchestrator component 303 of the quantum system 301.

In response to execution of the modified quantum circuits 285, the quantum system 301 can output and/or otherwise make available a corresponding set of quantum measurement readouts 320.

Discussion now turns to the evaluation component 222, which generally can generate a reshaped quantum channel 289 based on application of the quantum twirling, using the fixed distribution 282, where the quantum twirling can be directed by the system 202. That is, based on these quantum measurement readouts 320, the quantum system 301 and/or the classical system 202 (e.g., the evaluation component 222) can generate a set of corresponding expectation values 286. The evaluation component 222 can average the expectation values 286 resulting from the execution of the set of modified quantum circuits 285 to generate an average expectation value 288, upon which the reshaped noise channel 289 (Λ_{R}(ρ)) can be based. The resulting reshaped quantum channel 289 can be analyzed, noise mitigated, and/or employed for use in a quantum circuit executed at the quantum system 301, without being limited thereto.

Turning next to FIGS. 4 and 5, illustrated are various schematic illustrations 400 (e.g., 411, 421, 431, 441 and 451) demonstrating one or more variations of use of the non-limiting system 200, which variations also can be applicable to the non-limiting system 100.

Schematic illustration 411 relates to use of batch sampling using a balanced fixed distribution of twirl groups. As used herein, “batch sampling” refers to a most basic permutation of twirl gates into the fixed distribution 282. For example, the grouping component 216 can determine that a single batch is to be employed relative to a single quantum channel 252A.

In one or more embodiments, identifiers {0, . . . , N−1} can be randomly permuted to get indices {index-1, . . . index-N}. Twirl gates can be applied to the indices based on Equation 2: (index-j mod k)+1 relative to a circuit j. To avoid more occurrences of twirl gates with a lower index, the random permutation can be employed. At Equation 2, “mod” represents modulo as understood by one having ordinary skill in the art, and k represents the group size. For example, 7 modulo 3=1, where 3 is the group size (e.g., 7=2*3+1, where 1 is the modulo result).

An example implementation for sampling using a batch balanced approach can employ the following steps:

```
protocol batch-balanced-sampling(batch size, group size)
  mapping = random-permutation([1,...,group size])
  indices = random-permutation([1,...,batch size])
  for i = 1,... ,batch size
    indices[i] = mapping[indices[i] mod (group size)]
  end for
  return indices
end protocol.
```

Schematic illustration 421 relates to use of block sampling using a balanced fixed distribution of twirl groups. As used herein, “block sampling” refers to where twirls are sampled per block of k circuits. Per block, the twirl gates 1, . . . , k are randomly permuted and assigned to the block. The process is repeated until a specified overall batch size is reached. For example, the grouping component 216 can determine that one or more blocks 404 are to be employed.

In the particular example of schematic 421, various blocks 404 (e.g., blocks 404A, 404B and 404C) can be employed relative to a same quantum channel 252B. That is, the grouping component 216 can split a specified sample number 291 of quantum circuit samples to execute for generating the reshaped noise channel into a specified number of blocks 404. The compiling component 219 can thus employ a first fixed distribution of the specified set of twirl groups for a first block (e.g., first block 404A) of the blocks 404 and at least a second fixed distribution of a second specified set of second twirl groups for a second block (e.g., second block 404B) of the blocks 404. Or, alternatively, among other options, the compiling component 219 can employ a same fixed distribution for two or more of the first, second and third blocks 404.

An example implementation for sampling using a block balanced approach can employ the following steps:

```
protocol block-balanced-sampling(batch size, group size)
  indices = [ ]
  while (len(indices) < batch size) :
    indices = indices + random-permutation([1,...,group size])
  end while
  return indices[1:batch-size]
end protocol.
```

Schematic illustration 431 relates to quantum twirling employed for a readout quantum circuit, such as relative to a readout-error mitigation process. For example, a quantum channel 250R can represent whether or not a bitflip is performed for a particular iteration of a readout quantum circuit. Thus, the specified sample number 291 can correspond to the total number of iterations of the readout quantum circuit to be executed, and the corresponding specified set of twirls groups can comprise option 420A for using a bitflip and option 420B for not using a bitflip. Put another way, the distribution component 418 can determine the specified set of twirl groups comprising use and non-use of a bitflip corresponding to a quantum circuit (e.g., a readout quantum circuit) generated for readout out an aspect of a qubit 307 of the quantum processor 306.

At FIG. 5, schematic illustration 441 relates to combining noise shaping for a plurality of quantum channels (e.g., quantum channels 252C and 252D) of a same quantum circuit 250. For example, the distribution component 218 can employ the fixed distribution (e.g., relative to a first grouping 406A) for a first quantum channel 252A and a second fixed distribution of a second specified set of second twirl groups (e.g., grouping 406B) for the second quantum channel 252B. Put another way, the distribution component 218 can determine the fixed distribution of the specified set of twirl groups (e.g., group 406A) for the quantum channel (e.g., first quantum channel 252A) and a second fixed distribution of a second specified set of second twirl groups (e.g., group 406B) for a second quantum channel (e.g., second quantum channel 252B), and further combining, by the system (e.g., distribution component 218), the fixed distribution and the second fixed distribution for consideration of the quantum channel and the second quantum channel as a combined channel (e.g., relative to a combined fixed distribution of a combined group 408 of the groups 406A and 406B) for which the reshaped noise channel is generated, by the system (e.g., evaluation component 222).

In one or more embodiments, the distribution component 218 further can combine the fixed distribution and the second fixed distribution for consideration of the quantum channel and the second quantum channel as a combined channel (e.g., relative to a combined grouping 408).

Schematic illustration 451 relates to decoupling noise shaping for different qubits corresponding to a same quantum channel 252D to be executed over a plurality of qubits (e.g., two or more qubits). For example, where the quantum channel 252D is configured to be executed over a set of qubits 307 of the quantum processor 306, the specified set of twirl groups can be a first specified set of first twirl groups employed for a first qubit (e.g., qubit 307A) of a set of qubits, and the evaluation component 222 can employ a fixed distribution of a second specified set of second twirl groups for a second qubit (e.g., qubit 307B) of the set of qubits.

For example, the distribution component 218 can determine the fixed distribution based on a set sums of individual twirl groups of the specified set, and determine the second fixed distribution based on a second set of sums of individual twirl groups of the second specified set, wherein the set of sum is different from the second set of sums.

Put another way, larger twirls (such as a joint Pauli twirl over several qubits) can often be factored into smaller channels. Balanced twirling can be applied jointly over one or more of these smaller channels. For instance, for a four-qubit Pauli twirl, a balanced sampling can be desired for two sub-twirls, each consisting of two single-qubit Pauli twirls. Alternatively, given two independent single-qubit Pauli twirls, each of size 4, balanced sampling can be applied to the product of 16 elements, and provide that the two channels are sampled in a balanced manner simultaneously (correlated). In general, joint sampling can be applied for arbitrary twirls, e.g., different twirls on one or more same qubits, on twirls across qubits, and/or on similar twirls at different locations (temporal) within a quantum circuit.

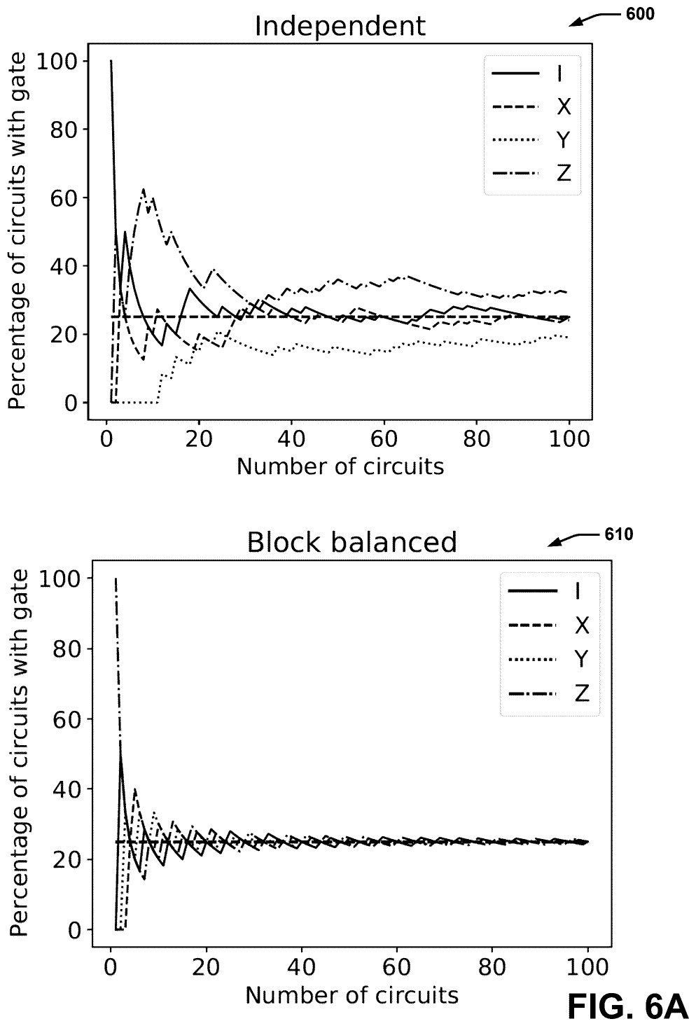

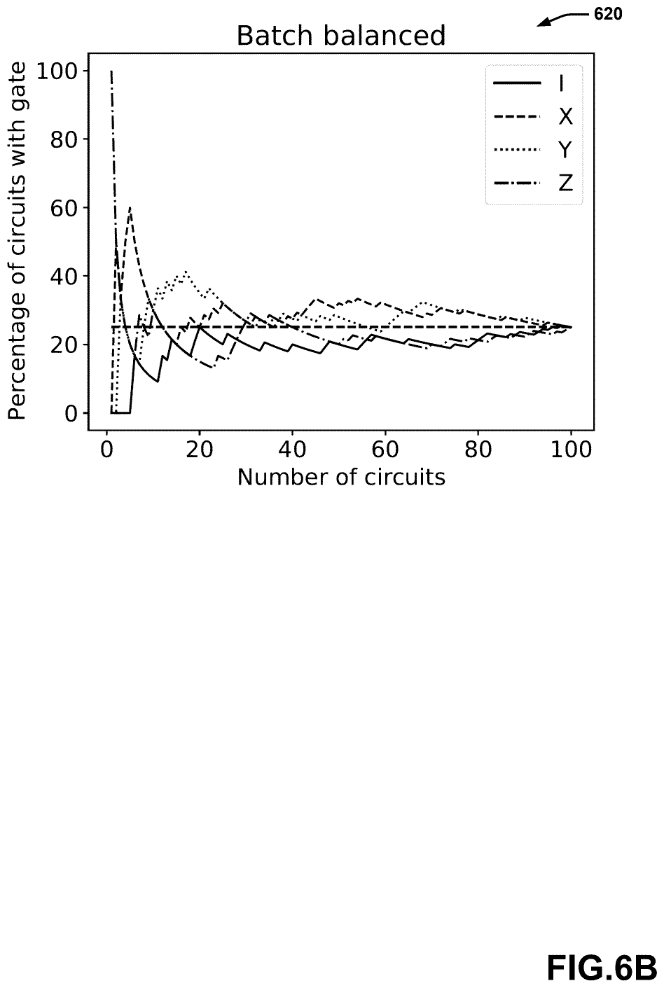

Discussion now turns to FIGS. 6A to 10B, illustrating various examples of fixed distribution balancing as can be performed by the one or more embodiments described herein (e.g., quantum channel noise shaping system 202 using quantum system 301).

At FIGS. 6A and 6B, illustrated are a set of graphs 600, 610 and 620 graphically illustrating the efficiency provided by use of the one or more frameworks described herein.

For example, a single-qubit Pauli twirl consisting of gates {I,X,Y,Z} can be sampled. A percentage of circuit instances in which each of the Pauli terms is sampled can be compared. Shown is the cumulative percentage for independent (graph 600), block-balanced (graph 610), and batch balanced (graph 620) sampling when using a batch size of 100. Block balanced sampling can be exactly balanced every four circuit instances relative to the set of twirl groups: {I,X,Y,Z}. Batch balanced can be balanced exactly over the full 100 circuits, such as being as equal as possible if the twirl size does not divide the batch size.

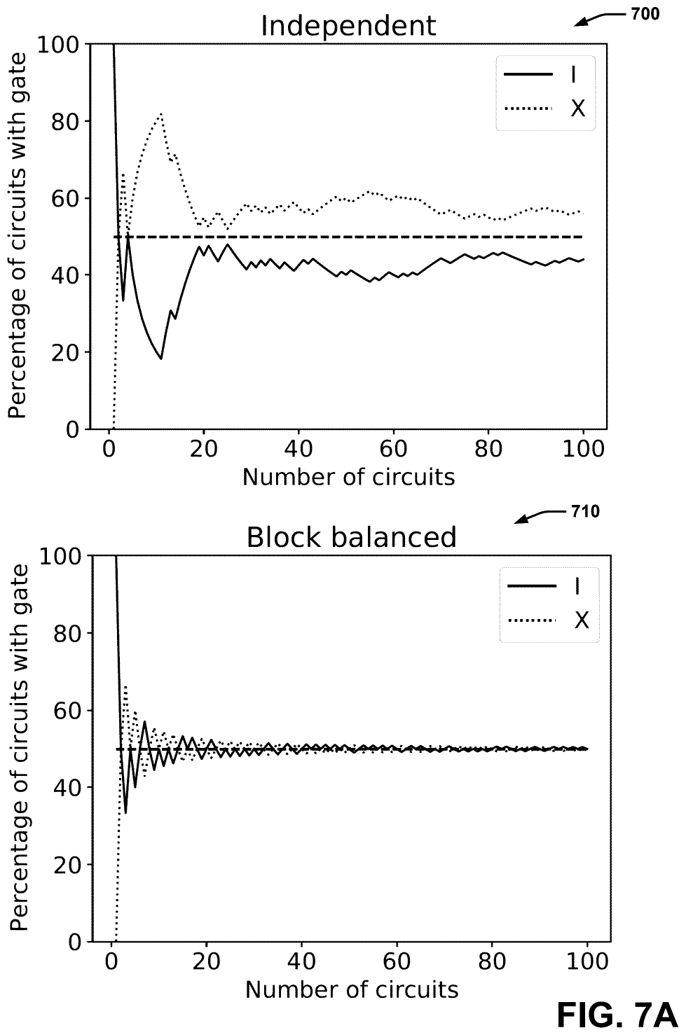

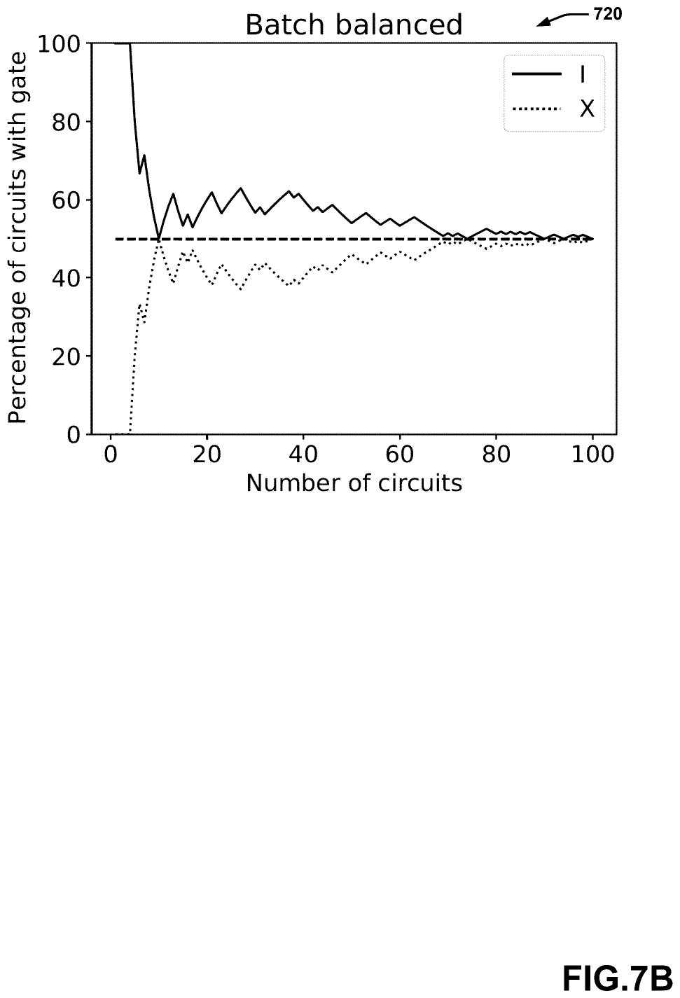

At FIGS. 7A and 7B, illustrated are a set of graphs 700, 710 and 720 graphically illustrating the efficiency provided by use of the one or more frameworks described herein, relative to readout quantum twirling applied to a quantum channel of a readout quantum circuit.

For example, {I,X} gates per qubit can be sampled. Shown is the percentage of circuit instances in which each of these terms is sampled. More particularly, shown is the cumulative percentage for independent (graph 700), block-balanced (graph 710), and batch balanced (graph 720) sampling when using a batch size of 100. Block balanced sampling can be exactly balanced can be exactly balanced every four circuit instances relative to the set of twirl groups: {I,X}. Batch balanced is balanced exactly over the full 100 circuits, such as being as equal as possible if the twirl size does not divide the batch size.

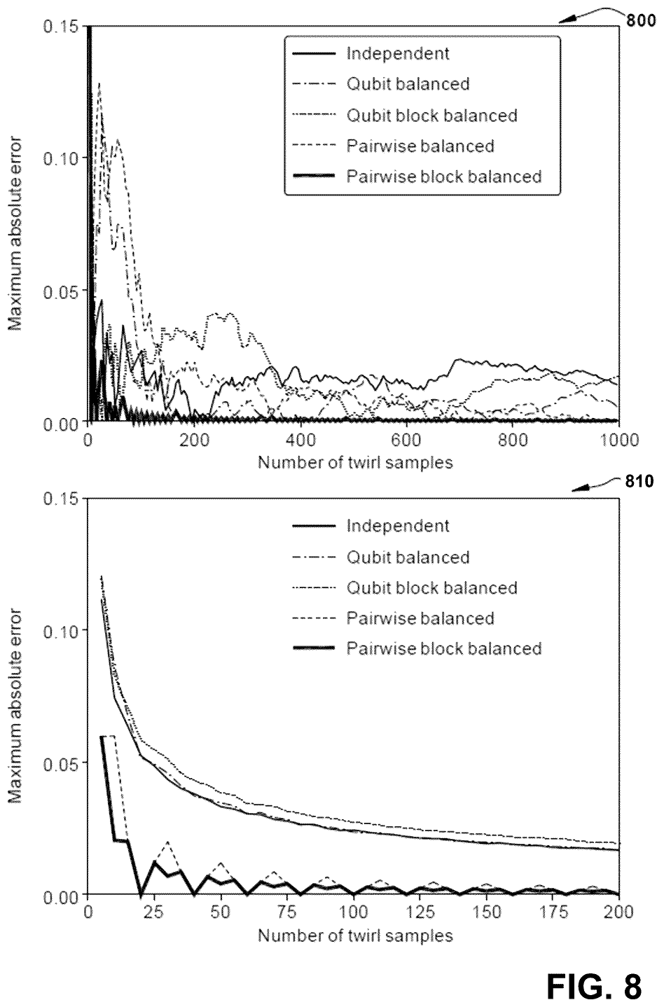

At FIG. 8, illustrated are a set of graphs 800 and 810 graphically illustrating an effect of balanced twirling on a setting where Pauli X and Y fidelity terms are averaged using an {I, Rz(pi/2)} twirl on each of two qubits. Balancing is done either per qubit, or simultaneously on both twirls (pairwise). Shown is averaging of fidelities [0.4, 1, 1, 0.4] corresponding to two-qubit terms {X,Y} by means of phase twirls. Graph 800 illustrates a single instance of the maximum absolute deviation of individual mixed fidelities from the average fidelity (0.7) as a function of the twirl samples. Graph 810 illustrates the same deviation when averaged over 5,000 twirl instances with the given number of samples.

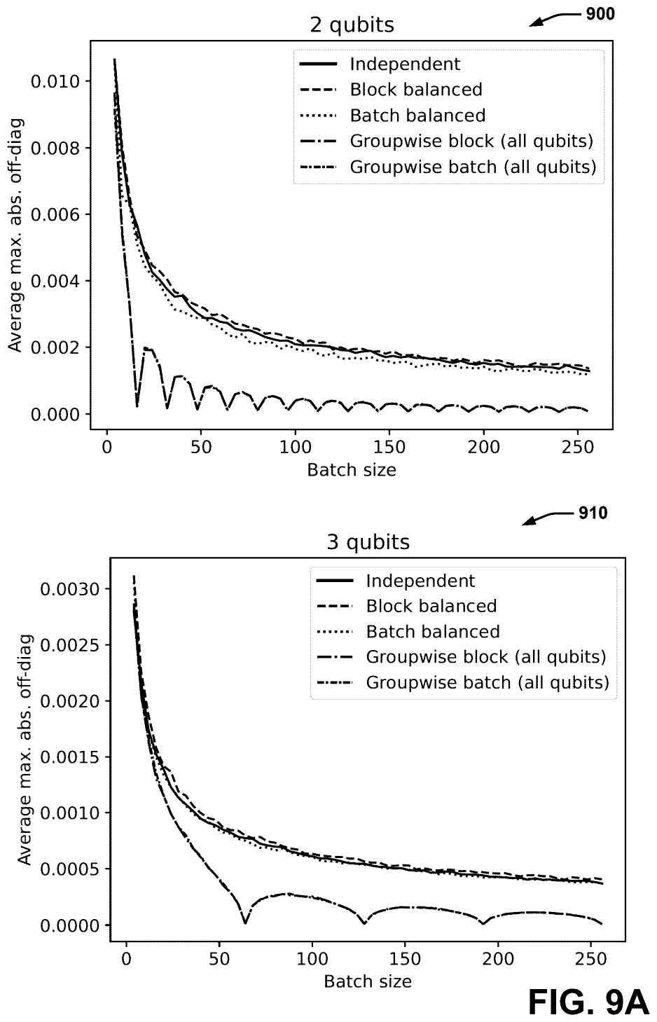

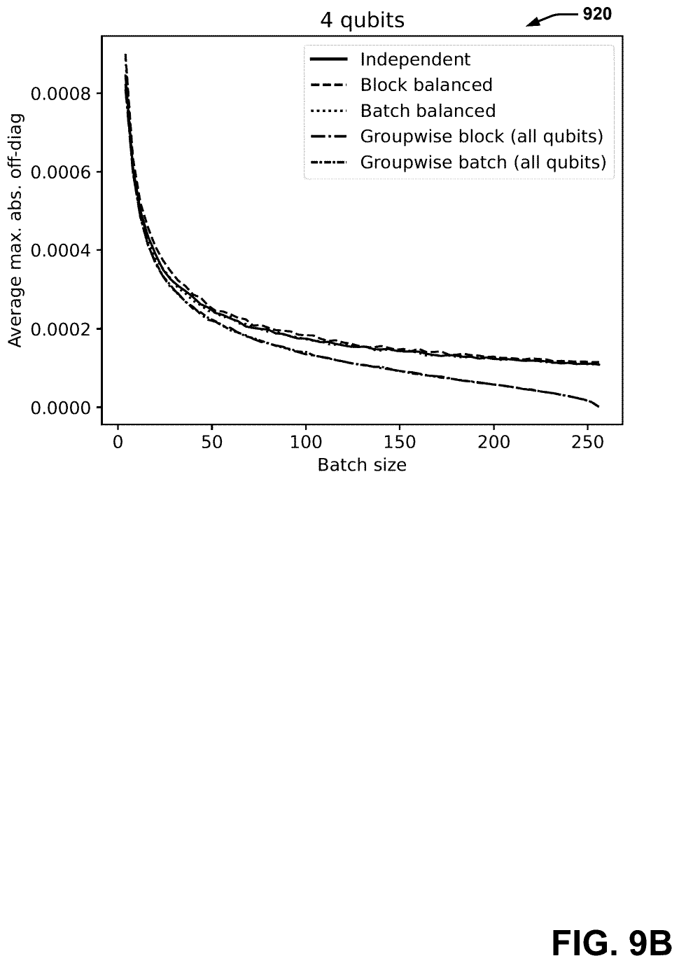

At FIGS. 9A and 9B, illustrated are a set of graphs 900, 910 and 920 graphically illustrating the efficiency provided by use of the one or more frameworks described herein as applied to a quantum channel employing varying numbers of qubits.

For example, a Pauli transfer matrix can be generated with the (N−1)×(N−1) non-identity block set as follows: a target fidelity f=0.9 on the diagonal, and all remaining elements (1−f)/(N−2). This is not a realistic map but can allow for studying zeroing out of off-diagonal elements using a Pauli twirl. Considered can be the average of the maximum absolute off-diagonal element over 100 trials with different twirl-sampling methods. For groupwise sampling (balanced sampling of the joint twirls on all qubits) the value will be zero when a full twirl is done (this is not generally the case for independent sampling, or qubit-wise sampling), but even for smaller batch sizes there is a benefit.

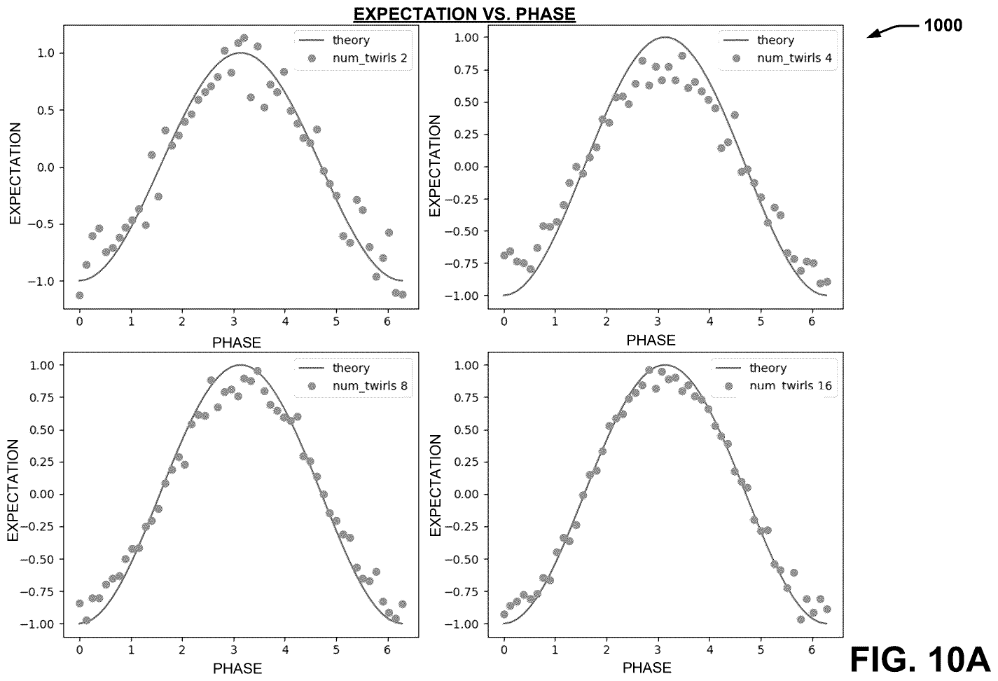

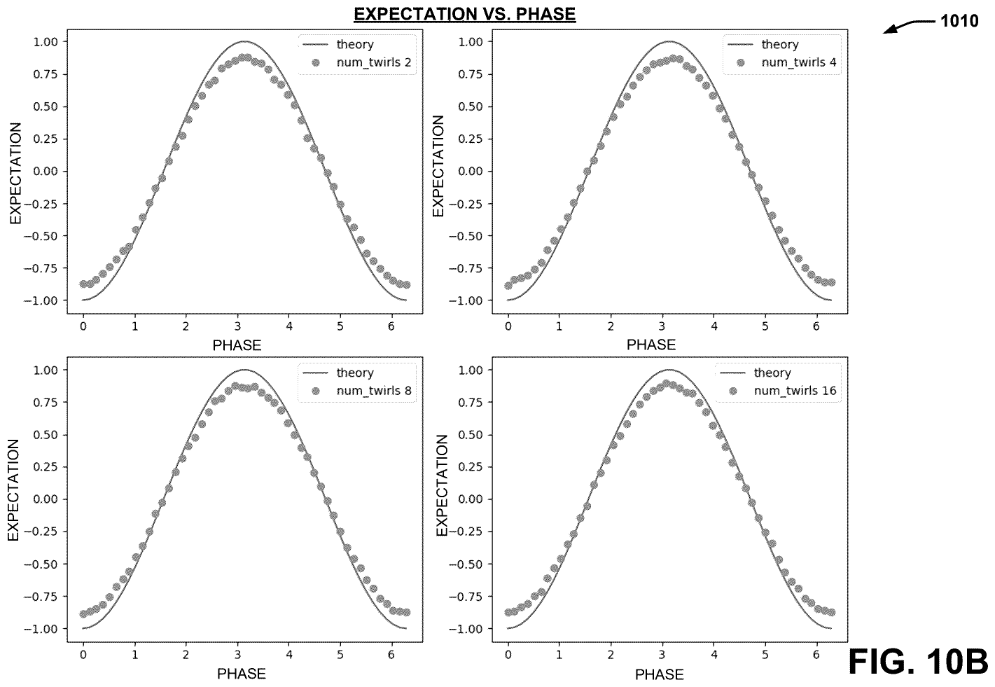

At FIGS. 10A and 10B, illustrated are a set of graphs 1000 and 1010 graphically illustrating the efficiency provided by use of the one or more frameworks described herein relative to additional readout examples.

For example, illustrated is twirling of qubit readout consist of inserting a random {I,X} gate prior to measurement, and undoing the operation classically, i.e., respectively keep the measurement bit as is, or negating it (flipping 0 to 1 and vice versa). A balanced sample can be obtained by sampling twirl bitstrings (0=I, 1=X) with a length corresponding to the number of qubits measured, and for each sampled bitstring also including the negated bitstring as a twirl instance. This results in an even number of 0 and 1 values per qubit. Depending on whether these negated bitstrings are applied directly after each sample, or whether the entire set of negated bitstrings is appended at the end we obtain block, respectively, batch balanced twirls (across qubits). Put another way, the graphs illustrate the difference in performance when the number of twirl instances is small.

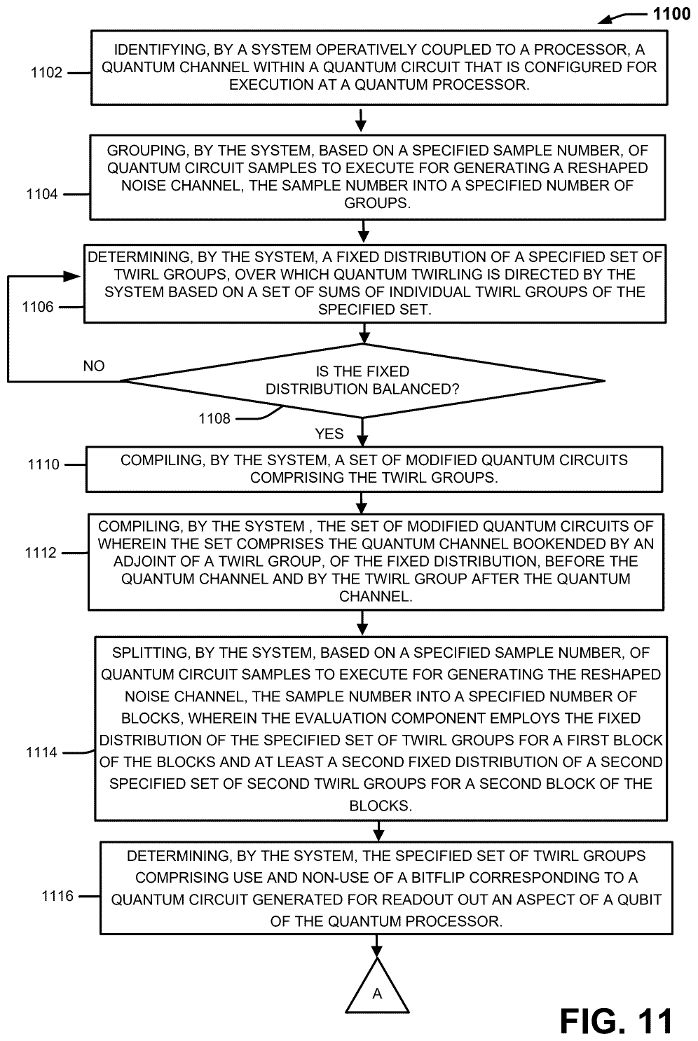

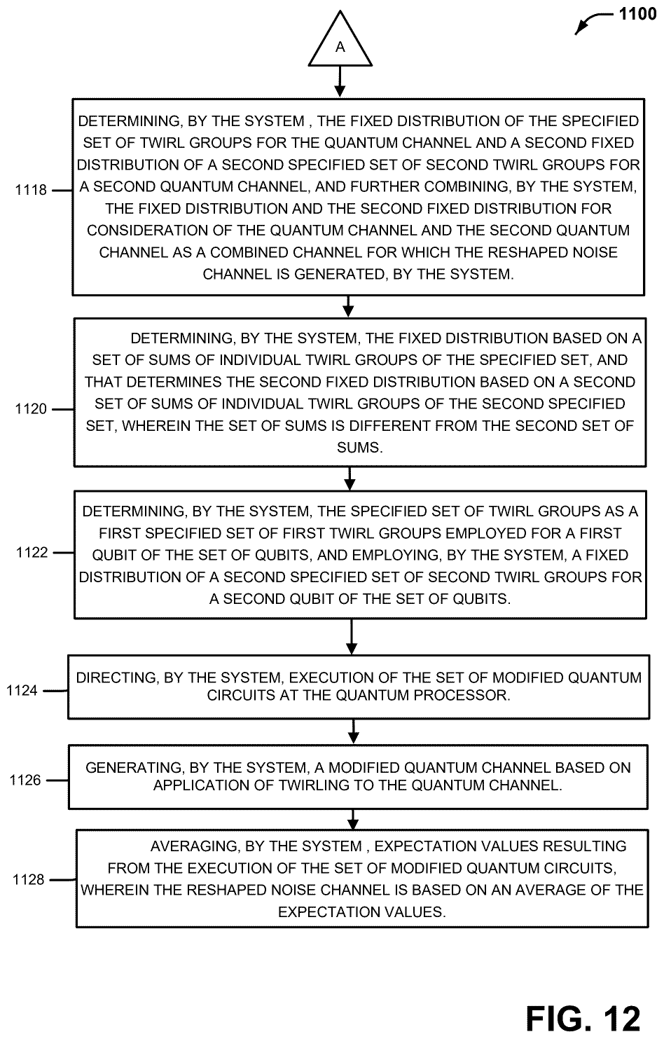

As a summary, referring next to FIGS. 11 and 12, illustrated is a flow diagram of an example, non-limiting method 1100 that can provide a process to provide shaping of noise of a quantum channel of a quantum circuit (or separate from a quantum circuit), in accordance with one or more embodiments described herein, such as the non-limiting system 200 of FIG. 2A. While the non-limiting method 1100 is described relative to the non-limiting system 200 of FIG. 2A, the non-limiting method 1100 can be applicable also to other systems described herein, such as the non-limiting system 100 of FIG. 1. Repetitive description of like elements and/or processes employed in respective embodiments is omitted for sake of brevity.

At 1102, the non-limiting method 1100 can comprise identifying, by a system operatively coupled to a processor (e.g., identification component 214), a quantum channel (e.g., quantum channel 252) within a quantum circuit (e.g., quantum circuit 250) that is configured for execution at a quantum processor (e.g., quantum processor 306).

At 1104, the non-limiting method 1100 can comprise grouping, by the system (e.g., grouping component 216), based on a specified sample number, of quantum circuit samples to execute for generating a reshaped noise channel (e.g., reshaped quantum channel 289), the sample number into a specified number of groups (e.g., blocks 404, batches 402, etc.).

At 1106, the non-limiting method 1100 can comprise determining, by the system (e.g., distribution component 218), a fixed distribution (e.g., fixed distribution 282) of a specified set (e.g., specified set 258) of twirl groups (e.g., twirl groups 256), over which quantum twirling is directed by the system based on a set of sums of individual twirl groups of the specified set.

At 1108, the non-limiting method 1100 can comprise determining, by the system (e.g., distribution component 218), whether the fixed distribution is balanced. For example, step 1108 can comprise, in one or more embodiments, determining, by they system (e.g., distribution component 218) whether a deviation of a sum of any one index relative to a sum of any other index is less than a specified deviation threshold (e.g., deviation threshold 284). If yes, the non-limiting method 1100 can proceed to step 1110. If no, the non-limiting method 1100 can proceed back to step 1106.

At 1110, the non-limiting method 1100 can comprise compiling, by the system (e.g., compiling component 219), a set of modified quantum circuits (e.g., modified quantum circuits 285) of comprising the twirl groups.

In one or more embodiments, at 1112, the non-limiting method 1100 can comprise compiling, by the system (e.g., compiling component 219), the set of modified quantum circuits wherein the set comprises the quantum channel bookended by an adjoint of a twirl group, of the fixed distribution, before the quantum channel and by the twirl group after the quantum channel.

In one or more embodiments, at 1114, the non-limiting method 1100 can comprise splitting, by the system (e.g., grouping component 216), based on a specified sample number, of quantum circuit samples to execute for generating the reshaped noise channel, the sample number into a specified number of blocks (e.g., blocks 404), wherein the compiling component employs the fixed distribution of the specified set of twirl groups for a first block (e.g., first block 404A) of the blocks and at least a second fixed distribution of a second specified set of second twirl groups for a second block (e.g., second block 404B) of the blocks. See, e.g., diagram 421 (FIG. 4).

In one or more embodiments, at 1116, the non-limiting method 1100 can comprise determining, by the system (e.g., distribution component 218), the specified set of twirl groups comprising use and non-use of a bitflip corresponding to a quantum circuit (e.g., a readout quantum circuit) generated for readout out an aspect of a qubit (e.g., qubit 307) of the quantum processor. See, e.g., diagram 431 (FIG. 4).

In one or more embodiments, at 1118, the non-limiting method 1100 can comprise determining, by the system (e.g., distribution component 218), the fixed distribution of the specified set of twirl groups (e.g., group 406A) for the quantum channel (e.g., first quantum channel 252A) and a second fixed distribution of a second specified set of second twirl groups (e.g., group 406B) for a second quantum channel (e.g., second quantum channel 252B), and further combining, by the system (e.g., distribution component 218), the fixed distribution and the second fixed distribution for consideration of the quantum channel and the second quantum channel as a combined channel (e.g., relative to a combined fixed distribution of a combined group 408 of the groups 406A and 406B) for which the reshaped noise channel is generated, by the system (e.g., evaluation component 222). See, e.g., diagram 441 (FIG. 5).

In one or more embodiments, at 1120, the non-limiting method 1100 can comprise determining, by the system (e.g., distribution component 218), the fixed distribution based on a set sums of individual twirl groups of the specified set, and that determines the second fixed distribution based on a second set of sums of individual twirl groups of the second specified set, wherein the set of sums is different from the second set of sums.

In one or more embodiments, at 1122, the non-limiting method 1100 can comprise determining, by the system (e.g., distribution component 218), the specified set of twirl groups as a first specified set of first twirl groups employed for a first qubit of a set of qubits, and employing, by the system (e.g., evaluation component 222), a fixed distribution of a second specified set of second twirl groups for a second qubit of the set of qubits. See, e.g., diagram 451 (FIG. 5).

At 1124, the non-limiting method 1100 can comprise directing, by the system (e.g., execution component 220), execution of the set of modified quantum circuits at the quantum processor.

At 1126, the non-limiting method 1100 can comprise generating, by the system (e.g., evaluation component 222), a reshaped quantum channel based on application of quantum twirling to the quantum channel.

At 1128, the non-limiting method 1100 can comprise averaging, by the system (e.g., evaluation component 222), expectation values (e.g., expectation values 286) resulting from the execution of the set of modified quantum circuits, wherein the reshaped noise channel is based on an average of the expectation values (e.g., averaged expectation value 288).

### Additional Summary

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. In addition, the computer-implemented and non-computer-implemented methodologies could alternatively be represented as a series of interrelated states via a state diagram or events. Additionally, the computer-implemented methodologies described hereinafter and throughout this specification are capable of being stored on an article of manufacture for transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

In summary, the one or more embodiments described herein can provide a system, computer-implemented method and/or computer program product to provide shaping of noise of a quantum channel of a quantum circuit. A system 100, 200 comprises a memory 104, 204 that stores and a processor 106, 206 that executes computer executable components stored in the memory 104, 204, wherein the computer executable components comprise an identification component that identifies a quantum channel within a quantum circuit that is configured for execution at a quantum processor, an evaluation component that generates a reshaped quantum channel based on application of quantum twirling to the quantum channel, and a distribution component that employs a fixed distribution of a specified set of twirl groups over which the quantum twirling is directed by the system.

A benefit of the system, computer-implemented method and/or computer program product can be an ability to, during quantum experiment setup, shape the noise of a noisy quantum channel in a manner that converges to the expectation value faster, using quantum twirling, than existing frameworks. Another benefit of the system, computer-implemented method and/or computer program product can be an ability to provide the noise shaping for readout quantum circuits, quantum circuits comprising multiple noisy channels, and/or noisy channels to be executed of a plurality of qubits. Yet another benefit of the system, computer-implemented method and/or computer program product can be an ability for use thereof with varying variations of modified quantum circuit grouping, including block sampling, batch sampling, batch-balanced sampling, repeated batch-balanced sampling, and/or a further variation of any of these variations, without being limited thereto.

Indeed, in view of the one or more embodiments described herein, a practical application of the one or more systems, computer-implemented methods and/or computer program products described herein can be an increased efficiency of quantum twirling applied to a quantum channel by providing for more accurate expectation values from execution of a set of modified quantum circuits used for the quantum twirling than from execution of a same number of quantum circuits used for quantum twirling based on an existing framework.

Accordingly, the applicant has discovered that employing a fixed distribution of twirl groups for a quantum twirling process, as opposed to employing a random distribution. The use of a fixed distribution can be employed relative to any quantum circuit grouping for the quantum twirling, such as, but not limited to, block sampling, batch sampling, batch-balanced sampling, repeated batch-balanced sampling, and/or a further variation of any of these variations. Further, the use of a fixed distribution can be employed for quantum twirling used to shape noise of various quantum circuits, such as, but not limited to, readout quantum circuits, quantum circuits comprising multiple noisy channels, and/or noisy channels to be executed of a plurality of qubits.

Indeed, any one or more such uses of a fixed distribution of twirl groups for a quantum twirling process can result in achieving an average expectation value being more accurate, use of the one or more embodiments described herein can allow for reduced and/or more efficient use of a quantum computer. This result is surprising because it has been traditionally believed that the determination of a set of twirl groups for noise shaping, whether performed randomly, such as using IID, or otherwise, would result in use of a quantity of twirl groups that deviate significantly from one another, overshoot equal distribution, and/or cause inefficient convergence or even overshoot of an expectation value being sought. See, for example, graph 600 and graph 700 illustrating the randomly distributed set of twirl groups failing to be equal, or close thereto, in view of deviations between numbers of quantum circuits respectively employing the different twirl groups.

Accordingly, it was unforeseen that specifying the twirl group distribution for use in a quantum twirling process could instead allow for a quantity of twirl groups that deviate less from one another, lessen chance of overshooting equal distribution, and/or enable efficient convergence or less overshoot of an expectation value being sought (with each being as compared to existing frameworks), as described relative to the one or more embodiments described herein. Differently, see, for example, graphs 610, 620, 700, 710 and/or 720 illustrating the fixedly distributed set of twirl groups being equal, or close thereto, in view of lower deviations between numbers of quantum circuits respectively employing the different twirl groups, as compared to existing frameworks.

In connection therewith, the one or more embodiments described herein can provide useful and practical applications of computers, thus providing enhanced (e.g., improved and/or optimized) quantum system setup as compared to existing frameworks. Overall, such computerized tools can constitute a concrete and tangible technical improvement in the field of quantum processing.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can be, in one or more embodiments, inherently and/or inextricably tied to computer technology and cannot be implemented outside of a computing environment. For example, one or more processes performed by one or more embodiments described herein can more efficiently, and even more feasibly, provide program and/or program instruction execution, such as relative to noise channel shaping and subsequent efficient convergence of an averaged expectation value, as compared to existing systems and/or techniques unable to provide such efficiencies. Systems, computer-implemented methods and/or computer program products providing performance of these processes are of great utility in the fields of quantum computing and cannot be equally practicably implemented in a sensible way outside of a computing environment.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively automatically or even partially automatically perform quantum twirling using a fixed and/or balanced distribution of twirl groups as the one or more embodiments described herein can provide these processes. For another example, a human, or even thousands of humans, cannot efficiently, accurately and/or effectively automatically or even partially automatically execute a quantum circuit at a quantum computer as the one or more embodiments described herein can provide one or more processes related thereto. Moreover, neither can the human mind nor a human with pen and paper conduct these processes, as conducted by one or more embodiments described herein.

In one or more embodiments, one or more of the processes described herein can be performed by one or more specialized computers (e.g., a specialized processing unit, a specialized classical computer, a specialized quantum computer, a specialized hybrid classical/quantum system and/or another type of specialized computer) to execute defined tasks related to the one or more technologies describe above. One or more embodiments described herein and/or components thereof can be employed to solve new problems that arise through advancements in technologies mentioned above, employment of quantum computing systems, cloud computing systems, computer architecture and/or another technology.

One or more embodiments described herein can be fully operational towards performing one or more other functions (e.g., fully powered on, fully executed and/or another function) while also performing one or more of the one or more operations described herein.

To provide additional summary, a listing of embodiments and features thereof is provided.

A system, comprising: a memory that stores computer executable components; and a processor that executes the computer executable components stored in the memory, wherein the computer executable components comprise: an identification component that identifies a quantum channel within a quantum circuit that is configured for execution at a quantum processor; an evaluation component that generates a reshaped quantum channel based on application of quantum twirling to the quantum channel; and a distribution component that employs a fixed distribution of a specified set of twirl groups over which the quantum twirling is directed by the system.

The system of the preceding paragraph, wherein the distribution component determines the fixed distribution based on a set of sums of individual twirl groups of the specified set, and wherein a deviation of a sum of any one index relative to a sum of any other index is less than a specified deviation threshold.

The system of any preceding paragraph, wherein the twirl groups of the specified set comprise use and non-use of a bitflip corresponding to a quantum circuit generated for readout out an aspect of a qubit of the quantum processor.

The system of any preceding paragraph, wherein the quantum channel is configured to be executed over a set of qubits of the quantum processor, wherein the specified set of twirl groups is a first specified set of first twirl groups employed for a first qubit of a set of qubits, and wherein the compiling component employs a second fixed distribution of a second specified set of second twirl groups for a second qubit of the set of qubits.

The system of any preceding paragraph, wherein the quantum circuit comprises the quantum channel and a second quantum channel, wherein the distribution component employs the fixed distribution for the quantum channel and a second fixed distribution of a second specified set of second twirl groups for the second quantum channel, and wherein the distribution component further combines the fixed distribution and the second fixed distribution for consideration of the quantum channel and the second quantum channel as a combined channel for which the evaluation component generates the reshaped quantum channel.

The system of any preceding paragraph, further comprising: a grouping component that, based on a specified sample number, of quantum circuit samples to execute for generating the reshaped quantum channel, splits the sample number into a specified number of groups, and a compiling component that employs the fixed distribution of the specified set of twirl groups for a first block of the blocks and at least a second fixed distribution of a second specified set of second twirl groups for a second block of the blocks.

The system of any preceding paragraph, wherein the distribution component determines the fixed distribution based on a set of sums of individual twirl groups of the specified set, and that determines the second fixed distribution based on a second set of sums of individual twirl groups of the second specified set, and wherein the set of sums is different from the second set of sums.

The system of any preceding paragraph, wherein application of the quantum twirling comprises compiling, by a compiling component of the system, a set of modified quantum circuits comprising the twirl groups, wherein the modified quantum circuits of the set comprise the quantum channel bookended by an adjoint of a twirl group, of the fixed distribution, before the quantum channel and by the twirl group after the quantum channel.

The system of any preceding paragraph, further comprising: an execution component that directs execution of the set of modified quantum circuits at the quantum processor.

The system of any preceding paragraph, wherein the evaluation component averages expectation values resulting from the execution of the set of modified quantum circuits, wherein the reshaped quantum channel is based on an average of the expectation values.

A computer-implemented method, comprising: identifying, by a system operatively coupled to a processor, a quantum channel within a quantum circuit that is configured for execution at a quantum processor; generating, by the system, a reshaped quantum channel based on application of quantum twirling to the quantum channel; and employing, by the system, a fixed distribution of a specified set of twirl groups over which the quantum twirling is directed by the system.

The computer-implemented method of the preceding paragraph, further comprising: determining, by the system, the fixed distribution based on a set of sums of individual twirl groups of the specified set, wherein a deviation of a sum of any one index relative to a sum of any other index is less than a specified deviation threshold.

The computer-implemented method of any preceding paragraph, wherein application of the quantum twirling comprises compiling, by the system, a set of modified quantum circuits comprising the twirl groups, wherein the modified quantum circuits of the set comprise the quantum channel bookended by an adjoint of a twirl group, of the fixed distribution, before the quantum channel and by the twirl group after the quantum channel.

The computer-implemented method of any preceding paragraph, further comprising: directing, by the system, execution of the set of modified quantum circuits at the quantum processor; and averaging, by the system, expectation values resulting from the execution of the set of modified quantum circuits, wherein the reshaped quantum channel is based on an average of the expectation values.

The computer-implemented method of any preceding paragraph, wherein the twirl groups of the specified set comprise use and non-use of a bitflip corresponding to a quantum circuit generated for readout out an aspect of a qubit of the quantum processor.

The computer-implemented method of any preceding paragraph, wherein the quantum channel is configured to be executed over a set of qubits of the quantum processor, wherein the specified set of twirl groups is a first specified set of first twirl groups employed for a first qubit of a set of qubits, and further comprising employing, by the system, a second fixed distribution of a second specified set of second twirl groups for a second qubit of the set of qubits.

A computer program product facilitating a process to provide shaping of noise of a quantum channel of a quantum circuit, the computer program product comprising a computer readable storage medium having program instructions embodied therewith, the program instructions executable by a processor to cause the processor to: identify, by the processor, the quantum channel within the quantum circuit that is configured for execution at a quantum processor; generate, by the processor, a reshaped quantum channel based on application of quantum twirling to the quantum channel; and employ, by the processor, a fixed distribution of a specified set of twirl groups over which the quantum twirling is directed by the system.

The computer program product of the preceding paragraph, wherein the program instructions are further executable by the processor to cause the processor to: determine, by the processor, the fixed distribution based on a set of sums of individual twirl groups of the specified set, wherein a deviation of a sum of any one index relative to a sum of any other index is less than a specified deviation threshold.

The computer program product of any preceding paragraph, wherein the program instructions are further executable by the processor to cause the processor to: compile, by the processor, a set of modified quantum circuits comprising the twirl groups, wherein the modified quantum circuits of the set comprise the quantum channel bookended by an adjoint of a twirl group, of the fixed distribution, before the quantum channel and by the twirl group after the quantum channel.

The computer program product of any preceding paragraph, wherein the program instructions are further executable by the processor to cause the processor to: direct, by the processor, execution of the set of modified quantum circuits at the quantum processor; and average, by the processor, expectation values resulting from the execution of the set of modified quantum circuits, wherein the reshaped quantum channel is based on an average of the expectation values.

### Computing Environment Description

Turning next to FIG. 13, a detailed description is provided of additional context for the one or more embodiments described herein at FIGS. 1-12.

FIG. 13 and the following discussion are intended to provide a brief, general description of a suitable computing environment 1300 in which one or more embodiments described herein at FIGS. 1-12 can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1300 contains an example of an environment for the execution of at least some of the computer code involved in performing the inventive methods, such as translation of an original source code based on a configuration of a target system by the quantum channel noise shaping code 1380. In addition to block 1380, computing environment 1300 includes, for example, computer 1301, wide area network (WAN) 1302, end user device (EUD) 1303, remote server 1304, public cloud 1305, and private cloud 1306. In this embodiment, computer 1301 includes processor set 1310 (including processing circuitry 1320 and cache 1321), communication fabric 1311, volatile memory 1312, persistent storage 1313 (including operating system 1322 and block 1380, as identified above), peripheral device set 1314 (including user interface (UI), device set 1323, storage 1324, and Internet of Things (IoT) sensor set 1325), and network module 1315. Remote server 1304 includes remote database 1330. Public cloud 1305 includes gateway 1340, cloud orchestration module 1341, host physical machine set 1342, virtual machine set 1343, and container set 1344.

COMPUTER 1301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1330. As is well understood in the art of computer technology, and depending upon the technology, performance of a computer-implemented method may be distributed among multiple computers and/or between multiple locations. On the other hand, in this presentation of computing environment 1300, detailed discussion is focused on a single computer, specifically computer 1301, to keep the presentation as simple as possible. Computer 1301 may be located in a cloud, even though it is not shown in a cloud in FIG. 13. On the other hand, computer 1301 is not required to be in a cloud except to any extent as may be affirmatively indicated.

PROCESSOR SET 1310 includes one, or more, computer processors of any type now known or to be developed in the future. Processing circuitry 1320 may be distributed over multiple packages, for example, multiple, coordinated integrated circuit chips. Processing circuitry 1320 may implement multiple processor threads and/or multiple processor cores. Cache 1321 is memory that is located in the processor chip package and is typically used for data or code that should be available for rapid access by the threads or cores running on processor set 1310. Cache memories are typically organized into multiple levels depending upon relative proximity to the processing circuitry. Alternatively, some, or all, of the cache for the processor set may be located “off chip.” In some computing environments, processor set 1310 may be designed for working with qubits and performing quantum computing.

Computer readable program instructions are typically loaded onto computer 1301 to cause a series of operational steps to be performed by processor set 1310 of computer 1301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1321 and the other storage media discussed below. The program instructions, and associated data, are accessed by processor set 1310 to control and direct performance of the inventive methods. In computing environment 1300, one or more instructions for performing the inventive methods may be stored in block 1380 in persistent storage 1313.

COMMUNICATION FABRIC 1311 is the signal conduction path that allows the various components of computer 1301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1312 is any type of volatile memory now known or to be developed in the future. Examples include dynamic type random access memory (RAM) or static type RAM. Typically, the volatile memory is characterized by random access, but this is not required unless affirmatively indicated. In computer 1301, the volatile memory 1312 is located in a single package and is internal to computer 1301, but, alternatively or additionally, the volatile memory may be distributed over multiple packages and/or located externally with respect to computer 1301.

PERSISTENT STORAGE 1313 is any form of non-volatile storage for computers that is now known or to be developed in the future. The non-volatility of this storage means that the stored data is maintained regardless of whether power is being supplied to computer 1301 and/or directly to persistent storage 1313. Persistent storage 1313 may be a read only memory (ROM), but typically at least a portion of the persistent storage allows writing of data, deletion of data and re-writing of data. Some familiar forms of persistent storage include magnetic disks and solid-state storage devices. Operating system 1322 may take several forms, such as various known proprietary operating systems or open-source Portable Operating System Interface type operating systems that employ a kernel. The code included in block 1380 typically includes at least some of the computer code involved in performing the inventive methods.

PERIPHERAL DEVICE SET 1314 includes the set of peripheral devices of computer 1301. Data communication connections between the peripheral devices and the other components of computer 1301 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1323 may include components such as a display screen, speaker, microphone, wearable devices (such as goggles and smart watches), keyboard, mouse, printer, touchpad, game controllers, and haptic devices. Storage 1324 is external storage, such as an external hard drive, or insertable storage, such as an SD card. Storage 1324 may be persistent and/or volatile. In some embodiments, storage 1324 may take the form of a quantum computing storage device for storing data in the form of qubits. In embodiments where computer 1301 is required to have a large amount of storage (for example, where computer 1301 locally stores and manages a large database) then this storage may be provided by peripheral storage devices designed for storing large amounts of data, such as a storage area network (SAN) that is shared by multiple, geographically distributed computers. IoT sensor set 1325 is made up of sensors that can be used in Internet of Things applications. For example, one sensor may be a thermometer and another sensor may be a motion detector.

NETWORK MODULE 1315 is the collection of computer software, hardware, and firmware that allows computer 1301 to communicate with other computers through WAN 1302. Network module 1315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1315 are performed on the same physical hardware device. In other embodiments (for example, embodiments that utilize software-defined networking (SDN)), the control functions and the forwarding functions of network module 1315 are performed on physically separate devices, such that the control functions manage several different network hardware devices. Computer readable program instructions for performing the inventive methods can typically be downloaded to computer 1301 from an external computer or external storage device through a network adapter card or network interface included in network module 1315.

WAN 1302 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1303 is any computer system that is used and controlled by an end user (for example, a customer of an enterprise that operates computer 1301) and may take any of the forms discussed above in connection with computer 1301. EUD 1303 typically receives helpful and useful data from the operations of computer 1301. For example, in a hypothetical case where computer 1301 is designed to provide a recommendation to an end user, this recommendation would typically be communicated from network module 1315 of computer 1301 through WAN 1302 to EUD 1303. In this way, EUD 1303 can display, or otherwise present, the recommendation to an end user. In some embodiments, EUD 1303 may be a client device, such as thin client, heavy client, mainframe computer, desktop computer and so on.

REMOTE SERVER 1304 is any computer system that serves at least some data and/or functionality to computer 1301. Remote server 1304 may be controlled and used by the same entity that operates computer 1301. Remote server 1304 represents the machine that collects and stores helpful and useful data for use by other computers, such as computer 1301. For example, in a hypothetical case where computer 1301 is designed and programmed to provide a recommendation based on historical data, then this historical data may be provided to computer 1301 from remote database 1330 of remote server 1304.

PUBLIC CLOUD 1305 is any computer system available for use by multiple entities that provides on-demand availability of computer system resources and/or other computer capabilities, especially data storage (cloud storage) and computing power, without direct active management by the scale. The direct and active management of the computing resources of public cloud 1305 is performed by the computer hardware and/or software of cloud orchestration module 1341. The computing resources provided by public cloud 1305 are typically implemented by virtual computing environments that run on various computers making up the computers of host physical machine set 1342, which is the universe of physical computers in and/or available to public cloud 1305. The virtual computing environments (VCEs) typically take the form of virtual machines from virtual machine set 1343 and/or containers from container set 1344. It is understood that these VCEs may be stored as images and may be transferred among and between the various physical machine hosts, either as images or after instantiation of the VCE. Cloud orchestration module 1341 manages the transfer and storage of images, deploys new instantiations of VCEs and manages active instantiations of VCE deployments. Gateway 1340 is the collection of computer software, hardware, and firmware that allows public cloud 1305 to communicate via WAN 1302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1306 is similar to public cloud 1305, except that the computing resources are only available for use by a single enterprise. While private cloud 1306 is depicted as being in communication with WAN 1302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1305 and private cloud 1306 are both part of a larger hybrid cloud.

### Additional Closing Information

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
an identification component that identifies a quantum channel within a quantum circuit that is configured for execution at a quantum processor;
an evaluation component that generates a reshaped quantum channel based on application of quantum twirling to the quantum channel; and
a distribution component that employs a fixed distribution of a specified set of twirl groups over which the quantum twirling is directed by the system.

2. The system of claim 1, wherein the distribution component determines the fixed distribution based on a set of sums of individual twirl groups of the specified set, and
wherein a deviation of a sum of any one index relative to a sum of any other index is less than a specified deviation threshold.

3. The system of claim 1, wherein the twirl groups of the specified set comprise use and non-use of a bitflip corresponding to a quantum circuit generated for readout out an aspect of a qubit of the quantum processor.

4. The system of claim 1, wherein the quantum channel is configured to be executed over a set of qubits of the quantum processor,
wherein the specified set of twirl groups is a first specified set of first twirl groups employed for a first qubit of a set of qubits, and
wherein the compiling component employs a second fixed distribution of a second specified set of second twirl groups for a second qubit of the set of qubits.

5. The system of claim 1, wherein the quantum circuit comprises the quantum channel and a second quantum channel,
wherein the distribution component employs the fixed distribution for the quantum channel and a second fixed distribution of a second specified set of second twirl groups for the second quantum channel, and
wherein the distribution component further combines the fixed distribution and the second fixed distribution for consideration of the quantum channel and the second quantum channel as a combined channel for which the evaluation component generates the reshaped quantum channel.

6. The system of claim 1, further comprising:
a grouping component that, based on a specified sample number, of quantum circuit samples to execute for generating the reshaped quantum channel, splits the sample number into a specified number of groups; and
a compiling component that employs the fixed distribution of the specified set of twirl groups for a first block of the blocks and at least a second fixed distribution of a second specified set of second twirl groups for a second block of the blocks.

7. The system of claim 6, wherein the distribution component that determines the fixed distribution based on a set of sums of individual twirl groups of the specified set, and that determines the second fixed distribution based on a second set of sums of individual twirl groups of the second specified set, and
wherein the set of sums is different from the second set of sums.

8. The system of claim 1, wherein application of the quantum twirling comprises compiling, by a compiling component of the system, a set of modified quantum circuits comprising the twirl groups,
wherein the modified quantum circuits of the set comprise the quantum channel bookended by an adjoint of a twirl group, of the fixed distribution, before the quantum channel and by the twirl group after the quantum channel.

9. The system of claim 8, further comprising:
an execution component that directs execution of the set of modified quantum circuits at the quantum processor.

10. The system of claim 9, wherein the evaluation component averages expectation values resulting from the execution of the set of modified quantum circuits, wherein the reshaped quantum channel is based on an average of the expectation values.

11. A computer-implemented method, comprising:
identifying, by a system operatively coupled to a processor, a quantum channel within a quantum circuit that is configured for execution at a quantum processor;
generating, by the system, a reshaped quantum channel based on application of quantum twirling to the quantum channel; and
employing, by the system, a fixed distribution of a specified set of twirl groups over which the quantum twirling is directed by the system.

12. The computer-implemented method of claim 11, further comprising:
determining, by the system, the fixed distribution based on a set of sums of individual twirl groups of the specified set,
wherein a deviation of a sum of any one index relative to a sum of any other index is less than a specified deviation threshold.

13. The computer-implemented method of claim 11, wherein application of the quantum twirling comprises compiling, by the system, a set of modified quantum circuits comprising the twirl groups,
wherein the modified quantum circuits of the set comprise the quantum channel bookended by an adjoint of a twirl group, of the fixed distribution, before the quantum channel and by the twirl group after the quantum channel.

14. The computer-implemented method of claim 13, further comprising:
directing, by the system, execution of the set of modified quantum circuits at the quantum processor; and
averaging, by the system, expectation values resulting from the execution of the set of modified quantum circuits, wherein the reshaped quantum channel is based on an average of the expectation values.

15. The computer-implemented method of claim 11, wherein the twirl groups of the specified set comprise use and non-use of a bitflip corresponding to a quantum circuit generated for readout out an aspect of a qubit of the quantum processor.

16. The computer-implemented method of claim 11, wherein the quantum channel is configured to be executed over a set of qubits of the quantum processor, and
wherein the specified set of twirl groups is a first specified set of first twirl groups employed for a first qubit of a set of qubits, and
further comprising employing, by the system, a second fixed distribution of a second specified set of second twirl groups for a second qubit of the set of qubits.

17. A computer program product facilitating a process to provide shaping of noise of a quantum channel of a quantum circuit, the computer program product comprising a computer readable storage medium having program instructions embodied therewith, the program instructions executable by a processor to cause the processor to:
identify, by the processor, the quantum channel within the quantum circuit that is configured for execution at a quantum processor;
generate, by the processor, a reshaped quantum channel based on application of quantum twirling to the quantum channel; and
employ, by the processor, a fixed distribution of a specified set of twirl groups over which the quantum twirling is directed by the system.

18. The computer program product of claim 17, wherein the program instructions are further executable by the processor to cause the processor to:
determine, by the processor, the fixed distribution based on a set of sums of individual twirl groups of the specified set,
wherein a deviation of a sum of any one index relative to a sum of any other index is less than a specified deviation threshold.

19. The computer program product of claim 17, wherein the program instructions are further executable by the processor to cause the processor to:
compile, by the processor, a set of modified quantum circuits comprising the twirl groups,
wherein the modified quantum circuits of the set comprise the quantum channel bookended by an adjoint of a twirl group, of the fixed distribution, before the quantum channel and by the twirl group after the quantum channel.

20. The computer program product of claim 19, wherein the program instructions are further executable by the processor to cause the processor to:
direct, by the processor, execution of the set of modified quantum circuits at the quantum processor; and
average, by the processor, expectation values resulting from the execution of the set of modified quantum circuits, wherein the reshaped quantum channel is based on an average of the expectation values.
